(19) United States
(12) Patent Application Publication
(10) Pub. No.: US 2019/0190318 A1
(43) Pub. Date: Jun. 20, 2019

(54) SYSTEMS AND METHODS FOR WIRELESS POWER TRANSMISSION

(71) Applicant: Widyne Technologies Inc., Edmonton (CA)

(72) Inventors: Susanna Vital de Campos de Freitas, Edmonton (CA); Fabiano Cezar Domingos, Edmonton (CA); Rashid Mirzavand Boroujeni, Edmonton (CA); Pedram Mousavi Bafrooei, Edmonton (CA)

(21) Appl. No.: 16/218,380

(22) Filed: Dec. 12, 2018

Related U.S. Application Data
(60) Provisional application No. 62/598,884, filed on Dec. 14, 2017.

(51) Int. Cl. H02J 50/12; H01F 38/14; H02J 50/80; H02J 50/05; H02J 50/30

(52) U.S. Cl. CPC H02J 50/12; H01F 38/14; H02J 7/025; H02J 50/05; H02J 50/30; H02J 50/80

(57) ABSTRACT

There is provided a system for wireless power transmission, the system comprising: a transmit-side single conductor; a transmit-side single-ended coupler for transmitting power from an alternating current power source via the transmit-side single conductor; a transmit-side transmitting device for transferring power from the power source, wherein the transmit-side transmitting device is configured to be inductively coupled to the transmit-side single-ended coupler when the power source is operating at an operating frequency; a receive-side single conductor configured to be electrically coupled to the transmit-side single conductor; a receive-side single-ended coupler for receiving power from the power source via the receive-side single conductor; and a receive-side receiving device for transferring power to a load, wherein the receive-side receiving device is configured to be inductively coupled to the receive-side single-ended coupler when the power source is operating at the operating frequency, wherein the system is configured to be collectively at resonance when the power source is operating at the operating frequency.

### CROSS-REFERENCE TO RELATED APPLICATION

This application claims priority from U.S. Patent Application No. 62/598,884 filed Dec. 14, 2017, the contents of which is incorporated herein by reference in its entirety.

### TECHNICAL FIELD

The present disclosure relates to systems and methods for wireless power transmission.

### BACKGROUND

Typical wireless power transmission technology uses near-field magnetic induction. Generally, a power source generates an alternating current which is applied to a double-ended transmitting coil. The current in the coil generates a magnetic field which induces an electric current in a similar receiving coil, with a limited distance separating both coils. The induced electric current on the receiver side can then be used to power a load.

While wirelessly transmitting power in this manner can be useful and has some industrial and commercial applications, one problem faced when trying to practically deploy this technology is that transmission efficiency decreases significantly with the presence of metallic structures near the transmitting and receiving coils, or with the distance and misalignment between the transmitting and receiving coils. Attempts to address these issues are also generally not completely wireless in nature; for example proposed solutions may be dependent on a physical continuous metallic path in order to transfer the power.

The present disclosure seeks to provide new systems and methods for wireless power transmission that seek to address the deficiencies in the prior art.

### SUMMARY

Generally, there is provided a system for wireless and single-conductor power and data transmission, that may use different methods of coupling (short-circuit, capacitive and/or inductive coupling, for example) between two single-conductor structures, in order to allow power transfer in cases where it is not feasible to have a continuous metallic single-conductor for transmission. On a transmitter side, a power source may provide to a double-ended structure a power alternating at a desired frequency. The double-ended structure may be coupled to a single-ended structure, with one end connected to a single-conductor, while another end is left floating or connected, directly or through a reactive component, to any point of the single-ended structure. Additionally, the open end of each single-ended structure may be electrically attached to a conductive plate, or wire, for example, in order to fine tune the structure to the desired frequency, thereby increasing the efficiency of the system. The first single-conductor is electrically coupled to a second single-conductor on the receiver side. The electrical coupling between the single-conductors can be made using for example a capacitive or an inductive reactance. The second single-conductor may be connected to similar or specifically designed single-ended and double-ended structures, acting as a receiver for the power. Finally, the power received at the double-ended structure may be delivered to one or more loads through for example a direct electrical connection, additional electromagnetic couplers (capacitive and/or inductive), and/or opto-couplers.

The system may operate based on the frequency generated by the power source on the transmitter side. Thus, all components of the system may be designed to operate at such a frequency. In addition, different components of the system may resonate together according to a fraction of the wavelength of the generated frequency, which may be (but is not limited to) the first resonance of a quarter of the wavelength (λ/4). Therefore, for example, if both single-ended structures are identical, and the single-conductor structure is significantly small, both single-ended structures may have a length of λ/8 or λ/10, for instance. However, if the single-conductor structures increase in physical size, the single-ended structures must shrink to maintain the overall resonance.

In order to increase the efficiency of the system, matching and tuning networks may be added to the double-ended structures. The matching and tuning networks may allow the system to adapt itself to loads with different impedances, to differently shaped single-conductor structures, to changes in the system due to modifications in the environment, and to adjust the voltage received on the receiver side. The matching and tuning networks may be composed, for example, of one or more banks of variable capacitors arranged in parallel, and inductors arranged in series with the double-ended structures. The configuration of such circuits may be, for example, Tr- or L-shape. The variable capacitors may be designed as a voltage-controlled transistor capacitors. Fixed capacitors may be connected in series with variable capacitors, and both may be positioned in parallel with the double-ended structures.

The system comprises two single-conductor structures which may be composed of non-wire conducting structures, possibly with non-constant cross-sections. The two single-conductor structures are electrically coupled to one another, with the coupling being provided for example by any form of discrete or distributed reactance.

The system may further comprise one or more additional transmitter and receiver single-ended structures, each electrically coupled to the single-conductor structures. Such additional transmitter and receiver structures will contribute to the resonance of the system, and thus other structures in the system must be redesigned or readapted in order to maintain the resonance as required. Moreover, multiple frequencies may be generated by the power source in order to transmit power to multiple receivers. In this case, at each frequency the transmitter and the receiver assigned to that frequency resonate together according to a fraction of its respective wavelength.

The power source may comprise a resonant power amplifier which applies power to the transmitter coils. A matching circuit may be added between the transmitter coils and the amplifier. Communication between the transmitter and receiver sides may occur through the single-conductor structure, or independently of the single-conductor structure, via an auxiliary transmitter (using Bluetooth modules, for example). The system may furthermore be used as a sensor for distance and position localization, as well as data communication such as NFC communication.

In a first aspect of the disclosure, there is provided a receive-side system for wireless power transmission, the system comprising: a receive-side single conductor for electrically coupling to a transmit-side single conductor (or, according to some embodiments, a transmitter); a receive-side single-ended coupler for receiving power from an alternating current power source via the receive-side single conductor; a receive-side receiving device for transferring power to a load, wherein the receive-side receiving device is configured to be inductively coupled to the receive-side single-ended coupler, and be collectively at resonance with a transmit-side transmitting device, when the power source is operating at an operating frequency; and one or more discrete components electrically connected to the receive-side single conductor, wherein the one or more discrete components comprise one or more of a capacitor; a resistor; and an inductor.

The receive-side single-ended coupler may comprise first and second ends, and the receive-side single conductor may comprise a conducting structure electrically coupled to the receive-side single-ended coupled via the first end. The conducting structure may comprise a non-wire conducting structure. The conducting structure may comprise a non-constant cross-section. The first and second ends may be electrically connected in parallel to the conducting structure. The second end may be floating.

The receive-side single-ended coupler may comprise a helix with a resonant length approximately an eighth of a wavelength of a signal output by the power source, plus an integer multiple of a half wavelength of the signal.

The receive-side single-ended coupler may have a diameter significantly less than one tenth of a wavelength of a signal output by the power source.

The receive-side single-ended coupler may comprise a helix wrapped around a core.

The system may further comprise a receive-side coupler tuning network comprising at least one reactive discrete component connected in series with the receive-side single-ended coupler or in parallel across two locations along the receive-side single-ended coupler. The at least one reactive discrete component may comprise a first and a second capacitor, the first end of the receive-side single-ended coupler being electrically coupled to the conducting structure via the first capacitor, and the second end of the receive-side single-ended coupler being electrically coupled to the conducting structure via the second capacitor.

The system may further comprise a receiving device tuning network connected to the receive-side receiving device and for connecting to the load, the receiving device tuning network being configured to assist the receive-side receiving device being inductively coupled to the receive-side single-ended coupler, and being substantially at resonance, when the power source is operating at the operating frequency. The receive-side coupler tuning network may comprise a reactive component bank, the system may further comprise control circuitry configured to: (a) read a feedback parameter of the system; and (b) in response to the feedback parameter, adjust the reactance of the reactive component bank such that the feedback parameter approaches a target value. The receiving device tuning network may comprise a reactive component bank and wherein the system further comprises control circuitry configured to: (a) read a feedback parameter of the system; and (b) in response to the feedback parameter, adjust the reactance of the reactive component bank such that the feedback parameter approaches a target value. The control circuitry may comprise a processor and a computer-readable medium communicatively coupled to the processor and having stored thereon computer program code configured when executed by the processor to cause the processor to: (a) read the feedback parameter of the system; and (b) in response to the feedback parameter, iteratively adjust the reactance of the reactive component bank such that the feedback parameter approaches a target value and until a stop condition is satisfied. Iteratively adjusting the reactance of the reactive component bank may comprise, for each iteration: (a) creating a generation of genomes, wherein each of the genomes corresponds to a different reactance of the reactive component bank; and (b) for each of the genomes: (i) adjusting the reactance of the reactive component bank to the reactance corresponding to the genome; and (ii) reading the feedback parameter corresponding to the reactance of the genome.

The feedback parameter may be selected from a group consisting of: voltage measured across two nodes in the system; current measured through a node in the system; S-parameters of any component in the system; power delivered to any component in the system; signal-to-noise ratio; and bit error rate.

The reactive component bank may comprise multiple switches each of which is connected in series to a capacitor, and adjusting the reactance of the reactive component bank may comprise actuating the switches to different states.

The one or more discrete components may comprise one or more capacitors, the one or more capacitors may comprise capacitive plates separated by dielectrics, and one or more of the capacitive plates may comprise: an assembly for an electronic device, wherein the assembly comprises a conductive protective cover for the electronic device, or a protective cover for the electronic device and a conductive plate for positioning alongside the protective cover; a conductive plate comprised in a vehicle; a conductive portion of a conduit; a table assembly comprising a table and a conductive plate for positioning alongside the table; and a conductive coating.

The receive-side receiving device may comprise a coil or a toroid.

The system may further comprise the load connected to the receive-side receiving device. The load may comprise a module for communicating data to or from the load. The load may be connected to the receive-side receiving device by one or more of: capacitive coupling; magnetic coupling; and optical coupling.

The system may further comprise a reflector for one or more of: reflecting an electric or a magnetic field generated by the receive-side single-ended coupler or the receive-side receiving device, when the power source is operating at the operating frequency; and shielding a user from the one or more discrete components.

The receive-side single conductor may be at least partially coated with an insulating material.

The system may further comprise one or more additional pairs of: receive-side single-ended couplers for receiving power from the power source via the receive-side single conductor; and receive-side receiving devices for transferring power to one or more additional loads. The one or more additional receive-side receiving devices may be configured to be inductively coupled to the one or more additional receive-side single-ended couplers, and be substantially at resonance, when the power source is operating at the operating frequency.

The system may further comprise one or more receive-side resonators configured to be inductively coupled to the receive-side single-ended coupler and the receive-side receiving device.

The one or more receive-side resonators may be positioned at least partially between the receive-side single-ended coupler and the receive-side receiving device.

The one or more receive-side resonators may comprise one or more capacitive components for tuning the one or more receive-side resonators to be at resonance with the transmit-side transmitting device when the power source is operating at the operating frequency.

In a further aspect of the disclosure, there is provided, a transmit-side system for wireless power transmission, the system comprising: a transmit-side single conductor for electrically coupling to a receive-side single conductor (or, according to some embodiments, a receiver); a transmit-side single-ended coupler for transmitting power from an alternating current power source via the transmit-side single conductor; a transmit-side transmitting device for transferring power from the power source, wherein the transmit-side transmitting device is configured to be inductively coupled to the transmit-side single-ended coupler, and be collectively at resonance with a receive-side receiving device, when the power source is operating at an operating frequency; and one or more discrete components electrically connected to the transmit-side single conductor, wherein the one or more discrete components comprise one or more of a capacitor; a resistor; and an inductor.

The transmit-side single-ended coupler may comprise first and second ends, and the transmit-side single conductor may comprise a conducting structure electrically coupled to the transmit-side single-ended coupled via the first end. The conducting structure may comprise a non-wire conducting structure. The conducting structure may comprise a non-constant cross-section. The first and second ends may be electrically connected in parallel to the conducting structure. The second end may be floating.

The transmit-side single-ended coupler may comprise a helix with a resonant length approximately an eighth of a wavelength of a signal output by the power source, plus an integer multiple of a half wavelength of the signal.

The transmit-side single-ended coupler may have a diameter significantly less than one tenth of a wavelength of a signal output by the power source.

The transmit-side single-ended coupler may comprise a helix wrapped around a core.

The system may further comprise the power source. The power source may comprise a floating ground terminal and a power output terminal electrically and physically coupled to the conducting structure. The power output and ground terminals of the power source may be physically coupled to two locations on the transmit-side single-ended coupler.

The system may further comprise a transmit-side coupler tuning network comprising at least one reactive discrete component connected in series with the transmit-side single-ended coupler or in parallel across two locations along the transmit-side single-ended coupler. The at least one reactive discrete component may comprise a first and a second capacitor, the first end of the transmit-side single-ended coupler being electrically coupled to the conducting structure via the first capacitor, and the second end of the transmit-side single-ended coupler being electrically coupled to the conducting structure via the second capacitor.

The system may further comprise a transmitting device tuning network connected to the transmit-side transmitting device and for connecting to the power source, the transmitting device tuning network being configured to assist the transmit-side transmitting device being inductively coupled to the transmit-side single-ended coupler, and being substantially at resonance, when the power source is operating at the operating frequency. The transmit-side coupler tuning network may comprise a reactive component bank, and the system may further comprise control circuitry configured to: (a) read a feedback parameter of the system; and (b) in response to the feedback parameter, adjust the reactance of the reactive component bank such that the feedback parameter approaches a target value. The transmitting device tuning network may comprise a reactive component bank and wherein the system further comprises control circuitry configured to: (a) read a feedback parameter of the system; and (b) in response to the feedback parameter, adjust the reactance of the reactive component bank such that the feedback parameter approaches a target value. The control circuitry may comprise a processor and a computer-readable medium communicatively coupled to the processor and having stored thereon computer program code configured when executed by the processor to cause the processor to: (a) read the feedback parameter of the system; and (b) in response to the feedback parameter, iteratively adjust the reactance of the reactive component bank such that the feedback parameter approaches a target value and until a stop condition is satisfied. Iteratively adjusting the reactance of the reactive component bank may comprise, for each iteration: (a) creating a generation of genomes, wherein each of the genomes corresponds to a different reactance of the reactive component bank; and (b) for each of the genomes: (i) adjusting the reactance of the reactive component bank to the reactance corresponding to the genome; and (ii) reading the feedback parameter corresponding to the reactance of the genome.

The feedback parameter may be selected from a group consisting of: voltage measured across two nodes in the system; current measured through a node in the system; S-parameters of any component in the system; power delivered to any component in the system; signal-to-noise ratio; and bit error rate.

The reactive component bank may comprise multiple switches each of which is connected in series to a capacitor, and adjusting the reactance of the reactive component bank may comprise actuating the switches to different states.

The transmit-side transmitting device may comprise a coil or a toroid.

The system may further comprise the alternating current power source connected to the transmit-side transmitting device.

The system may further comprise a reflector for one or more of: reflecting an electric or a magnetic field generated by the receive-side single-ended coupler or the receive-side receiving device, when the power source is operating at the operating frequency; and shielding a user from the one or more discrete components.

The transmit-side single conductor may be at least partially coated with an insulating material.

The system may further comprise one or more additional pairs of: transmit-side single-ended couplers for transmitting power from the power source via the transmit-side single conductor; and transmit-side transmitting devices for transferring power from the power source, and the one or more additional transmit-side transmitting devices may be configured to be inductively coupled to the one or more additional transmit-side single-ended couplers, and be substantially at resonance, when the power source is operating at the operating frequency.

The one or more discrete components may comprise one or more capacitors, the one or more capacitors may comprise capacitive plates separated by dielectrics, and one or more of the capacitive plates may comprise: an assembly for an electronic device, wherein the assembly comprises a conductive protective cover for the electronic device, or a protective cover for the electronic device and a conductive plate for positioning alongside the protective cover; a conductive plate comprised in a vehicle; a conductive portion of a conduit; a table assembly comprising a table and a conductive plate for positioning alongside the table; and a conductive coating.

The system may further comprise one or more transmit-side resonators configured to be inductively coupled to the transmit-side single-ended coupler and the transmit-side transmitting device.

The one or more transmit-side resonators may be positioned at least partially between the transmit-side single-ended coupler and the transmit-side transmitting device.

The one or more transmit-side resonators may comprise one or more capacitive components for tuning the one or more transmit-side resonators to be at resonance with the receive-side receiving device when the power source is operating at the operating frequency.

In a further aspect of the disclosure, there is provided a system for wireless power transmission, the system comprising: a transmit-side single conductor (or, according to some embodiments, a transmitter); a transmit-side single-ended coupler for transmitting power from an alternating current power source via the transmit-side single conductor; a transmit-side transmitting device for transferring power from the power source, wherein the transmit-side transmitting device is configured to be inductively coupled to the transmit-side single-ended coupler when the power source is operating at an operating frequency; a receive-side single conductor (or, according to some embodiments, a receiver) configured to be electrically coupled to the transmit-side single conductor; a receive-side single-ended coupler for receiving power from the power source via the receive-side single conductor; and a receive-side receiving device for transferring power to a load, wherein the receive-side receiving device is configured to be inductively coupled to the receive-side single-ended coupler when the power source is operating at the operating frequency, wherein the system is configured to be collectively at resonance when the power source is operating at the operating frequency.

The system may further comprise one or more receive-side discrete components electrically connected to the receive-side single conductor, wherein the one or more receive-side discrete components comprise one or more of a capacitor; a resistor; and an inductor.

The system may further comprise one or more transmit-side discrete components electrically connected to the transmit-side single conductor, wherein the one or more transmit-side discrete components comprise one or more of a capacitor; a resistor; and an inductor.

The transmit-side single conductor may at least substantially enclose the receive-side single conductor. The receive-side single conductor may at least substantially enclose the transmit-side single conductor.

In a further aspect of the disclosure, there is provided a method of wirelessly transmitting power, comprising: providing a system comprising: at least one single conductor; a transmit-side single-ended coupler for transmitting power from an alternating current power source via the at least one single conductor; a transmit-side transmitting device for transferring power from the power source; a receive-side single-ended coupler for receiving power from the power source via the at least one single conductor; and a receive-side receiving device for transferring power to a load; and operating the power source at an operating frequency such that the system is collectively at resonance.

The at least one single conductor may comprise a transmit-side single conductor and a receive-side single conductor configured to be electrically coupled to one another.

The system may comprise an electromagnetic path length, and the method may further comprise adjusting the electromagnetic path length such that the system is collectively at resonance. The adjusting of the electrical path length may comprise adjusting an electrical path length of the receive-side single-ended coupler or the transmit-side single-ended coupler.

The system may further comprise one or more receive-side discrete components electrically connected to the receive-side single conductor, wherein the one or more receive-side discrete components comprise one or more of a capacitor; a resistor; and an inductor.

The system may further comprise one or more transmit-side discrete components electrically connected to the transmit-side single conductor, wherein the one or more transmit-side discrete components comprise one or more of a capacitor; a resistor; and an inductor.

The power source may be configured to emit an alternating current signal comprising data encoded therein, or the load may be configured to modulate an alternating current signal received from the power source so as to encode data in the alternating current signal.

The system may further comprise a receive-side coupler tuning network comprising at least one reactive discrete component connected in series with the receive-side single-ended coupler or in parallel across two locations along the receive-side single-ended coupler. The system may further comprise a transmit-side coupler tuning network comprising at least one reactive discrete component connected in series with the transmit-side single-ended coupler or in parallel across two locations along the transmit-side single-ended coupler. The method may further comprise adjusting a reactance of at least one of the coupler tuning networks such that the system is collectively at resonance.

The system may further comprise a receiving device tuning network connected between the receive-side receiving device and the load. The system may further comprise a transmitting device tuning network connected between the transmit-side transmitting device and the power source. The method may further comprise tuning at least one of the device tuning networks to assist the system being collectively at resonance when the power source is operating at the operating frequency.

The receive-side coupler tuning network and/or the transmit-side coupler tuning network may comprise a reactive component bank, and the system may further comprise control circuitry configured to: (a) read a feedback parameter of the system; and (b) in response to the feedback parameter, adjust the reactance of the reactive component bank such that the feedback parameter approaches a target value. The receiving device tuning network and/or the transmitting device tuning network may comprise a reactive component bank, and the system may further comprise control circuitry configured to: (a) read a feedback parameter of the system; and (b) in response to the feedback parameter, adjust the reactance of the reactive component bank such that the feedback parameter approaches a target value. The control circuitry may comprise a processor and a computer-readable medium communicatively coupled to the processor and having stored thereon computer program code configured when executed by the processor to cause the processor to: (a) read the feedback parameter of the system; and (b) in response to the feedback parameter, iteratively adjust the reactance of the reactive component bank such that the feedback parameter approaches a target value and until a stop condition is satisfied. Iteratively adjusting the reactance of the reactive component bank may comprise, for each iteration: (a) creating a generation of genomes, wherein each of the genomes corresponds to a different reactance of the reactive component bank; and (b) for each of the genomes: (i) adjusting the reactance of the reactive component bank to the reactance corresponding to the genome; and (ii) reading the feedback parameter corresponding to the reactance of the genome.

The system may further comprise at least one of: one or more additional pairs of: receive-side single-ended couplers for receiving power from the power source via the at least one single conductor; and receive-side receiving devices for transferring power to one or more additional loads; and one or more additional pairs of: transmit-side single-ended couplers for transmitting power from the power source via the at least one single conductor; and transmit-side transmitting devices for transferring power from the power source. The method may further comprise tuning the system such that the system is collectively at resonance when the power source is operating at the one or more additional operating frequencies.

The method may further comprise adaptively matching the receive-side receiving device to the load in response to changes in operating conditions. The changes in operating conditions may comprise at least one of: a change in distance between the receive-side single-ended coupler and the receive-side receiving device; a change in inductance of the load; and a change in alignment between the receive-side single-ended coupler and the receive-side receiving device.

In a further aspect of the disclosure, there is provided a receive-side system for wireless power transmission, the system comprising: a receive-side single conductor for electrically coupling to a transmit-side single conductor; a receive-side single-ended coupler for receiving power from an alternating current power source via the receive-side single conductor; a receive-side receiving device for transferring power to a load, wherein the receive-side receiving device is configured to be inductively coupled to the receive-side single-ended coupler, and be collectively at resonance with a transmit-side transmitting device, when the power source is operating at an operating frequency; and one or more capacitive plates.

In a further aspect of the disclosure, there is provided a transmit-side system for wireless power transmission, the system comprising: a transmit-side single conductor for electrically coupling to a receive-side single conductor; a transmit-side single-ended coupler for transmitting power from an alternating current power source via the transmit-side single conductor; a transmit-side transmitting device for transferring power from the power source, wherein the transmit-side transmitting device is configured to be inductively coupled to the transmit-side single-ended coupler, and be collectively at resonance with a receive-side receiving device, when the power source is operating at an operating frequency; and one or more capacitive plates.

In a further aspect of the disclosure, there is provided a system for wireless power transmission, the system comprising: a transmit-side single conductor; a transmit-side single-ended coupler for transmitting power from an alternating current power source via the transmit-side single conductor; a transmit-side transmitting device for transferring power from the power source, wherein the transmit-side transmitting device is configured to be inductively coupled to the transmit-side single-ended coupler when the power source is operating at an operating frequency; a receive-side single conductor configured to be electrically coupled to the transmit-side single conductor; a receive-side single-ended coupler for receiving power from the power source via the receive-side single conductor; and a receive-side receiving device for transferring power to a load, wherein the receive-side receiving device is configured to be inductively coupled to the receive-side single-ended coupler when the power source is operating at the operating frequency, wherein the transmit-side single conductor and the receive-side single conductor are not short-circuited together.

In a further aspect of the disclosure, there is provided a method of wirelessly transmitting power, comprising: providing a system comprising: a transmit-side single conductor and a receive-side single conductor; a transmit-side single-ended coupler for transmitting power from an alternating current power source via the transmit-side single conductor; a transmit-side transmitting device for transferring power from the power source; a receive-side single-ended coupler for receiving power from the power source via the receive-side single conductor; and a receive-side receiving device for transferring power to a load; and coupling the transmit-side single conductor and the receive-side single conductor without shorting-circuiting the transmit-side single conductor and the receive-side single conductor.

The method may further comprise operating the power source at an operating frequency such that the system is collectively at resonance.

In any of the embodiments described herein, the one or more discrete components may comprise any component having an input, an output, and being designed to ideally exhibit a capacitance, an inductance, or a resistance. The component may exhibit at most only a parasitic amount of any electrical property the component is not designed to exhibit. For example, for the purposes of this disclosure, a wire is not considered a discrete resistor notwithstanding the fact that the wire may have parasitic levels of resistance, for the reason that the wire is not designed exhibit a resistance.

In any of the embodiments described herein, the transmit-side single conductor may be replaced more generally with a transmitter, and the receive-side single conductor may be replaced more generally with a receiver.

### BRIEF DESCRIPTION OF THE DRAWINGS

Specific embodiments of the disclosure will now be described in detail in conjunction with the accompanying drawings, of which:

FIGS. 1A-1G show a system for combined wireless power transfer, according to various embodiments of the disclosure;

FIG. 1H shows a system for combined wireless power transfer, according to an embodiment of the disclosure;

FIG. 1I shows a system for combined wireless power transfer, according to an embodiment of the disclosure;

FIGS. 2A-2B show matching and tuning networks that can be added to the system of FIGS. 1A-1I;

FIGS. 3A-3B show the equivalent circuit of the system shown in FIGS. 1A-1I;

FIG. 4 shows an experimental setup of the system of FIGS. 2A-2B;

FIG. 5 shows a comparison of the efficiencies of different combinations in the number of turns in double-ended coils;

FIG. 6 shows the output power for the coils analyzed in FIG. 5;

FIG. 7 shows the real input impedance of the system of FIGS. 2A-2B, using the coils of FIGS. 5 and 6;

FIG. 8 shows the imaginary component of the input impedance of the system of FIGS. 2A-2B, using the coils of FIGS. 5-7;

FIG. 9 shows a comparison of the efficiencies of different spacings between capacitive plates;

FIG. 10 shows the output power of the two cases analyzed in FIG. 9;

FIG. 11 shows the real component of the input impedance of the system under the conditions of FIGS. 9 and 10;

FIG. 12 shows the imaginary part of the input impedance of the system under the conditions of FIGS. 9-11;

FIG. 13 shows a comparison of the efficiencies of the coils in FIG. 4 with and without the presence of matching and tuning networks;

FIG. 14 shows the output power of the system under the conditions used in FIG. 13;

FIG. 15 shows the real component of the input impedance of the system under the conditions used in FIGS. 13 and 14;

FIG. 16 shows the imaginary part of the input impedance of the system under the conditions used in FIGS. 13-15;

FIG. 17 shows the system being used for RFID communication;

FIG. 18 shows the matching and tuning networks used in the embodiment of FIG. 17;

FIG. 19 shows one example of the system being used for data communication, showing the power signal modulated using ASK modulation;

FIG. 20 shows an embodiment of the system of FIGS. 2A-2B;

FIGS. 21A-21B show an experimental setup of the system of FIG. 20;

FIGS. 22A-22B show the simulated and measured S-parameters of the system used in FIGS. 20 and 21A-21B;

FIG. 23 shows an embodiment of the system of FIGS. 2A-2B with both electric and magnetic couplings;

FIGS. 24A-24B show the simulated and measured S-parameters of the system used in FIG. 23;

FIGS. 25A-25B show the simulated electric and magnetic fields of the system used in FIG. 23;

FIG. 26 shows an embodiment of the system of FIG. 23 with three transmitter coils and one receiver;

FIG. 27 shows the simulated S-parameters of the system used in FIG. 26;

FIGS. 28A-28B show the simulated Poynting vectors of the system used in FIG. 26 when the receiver is over the middle and right transmitter coils, respectively

FIG. 29 shows an embodiment of the system of FIG. 26 with three transmitter coils and two receivers;

FIG. 30 shows the simulated S-parameters of the system used in FIG. 29;

FIG. 31 shows the simulated Poynting vectors of the system used in FIG. 26;

FIG. 32 shows an embodiment of the system of FIGS. 2A-2B with both electric and magnetic couplings and with one conductive plate at the transmitter;

FIG. 33 shows the simulated and measured S-parameters of the system used in FIG. 32; and

FIGS. 34A-34B show the simulated electric and magnetic fields of the system used in FIG. 32.

### DETAILED DESCRIPTION

The present disclosure seeks to provide systems and methods for wireless power transmission. While various embodiments of the disclosure are described below, the disclosure is not limited to these embodiments, and variations of these embodiments may well fall within the scope of the disclosure which is to be limited only by the appended claims.

Terms such as “coupling”, “couple”, “coupled”, “attach”, “attached”, “connect”, “connected” and its variants used in this disclosure are intended to include direct or indirect connections unless otherwise indicated. For instance, if a first circuit or device is coupled to a second circuit or device, that coupling method may be realized through a direct connection or through an indirect connection via other devices, circuits or connections.

The word “a” or “an” when used in conjunction with the term “comprising” or “including” may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The embodiments described herein relate to systems and methods for power and data wireless transfer through multiple single-conductors, or a single single-conductor with discontinuities. In these embodiments, different methods of coupling between the single-conductors may be used (capacitive or inductive coupling, for example), in order to allow for power transfer in cases where it is not feasible to have a continuous metallic structure for transmission. Thus, power and data may be transferred without the necessity of a continuous single-conductor. The system can be used to transfer power over tables and shelves that are not made of metal, for example, using a separate single-conductor on each side of the desired surface, with capacitive coupling between them, for example.

The single-conductors on both sides of the system may be arbitrarily shaped conducting structures, such as a wire or a non-conventional structure, such as a metallic shelf or table, or a metallic pipeline, for instance. Generally, the size of the single-conductors does not cause significant losses in power and data transmitted, as long as their size is kept relatively small when compared to the wavelength of operation. In some embodiments, the size of a single-conductor is not larger than λ/10 (e.g. 4.4 m at 6.78 MHz). Additionally, if the overall size of the system is kept within this range, the single-conductor structures will generally not significantly affect the resonant frequency of the system. Moreover, the resonant frequency of the topology described herein is defined by all of the double-ended and single-ended structures, as well as all of the single-conductors, the matching and tuning networks, and the load of the system, all taken together. In other words, the entire system should resonate at the desired frequency, as opposed to each individual component resonating independently of others. An equivalent circuit model of the system, including the coils and the single-conductors, is shown later and consolidated with measurements and simulations. In addition, an example method for building the double-ended and single-ended structures is demonstrated.

### System Outline

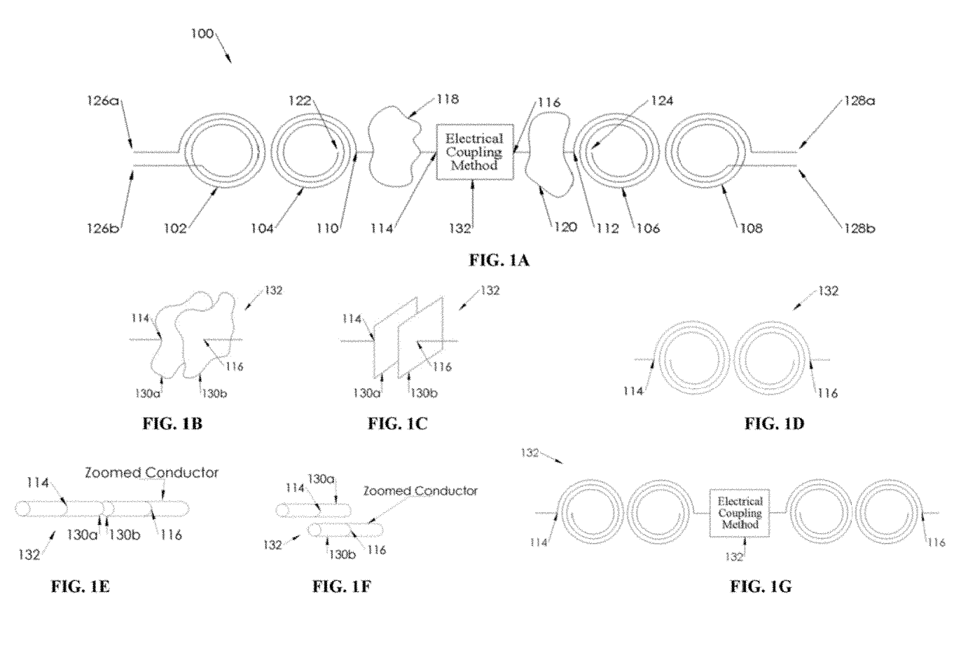

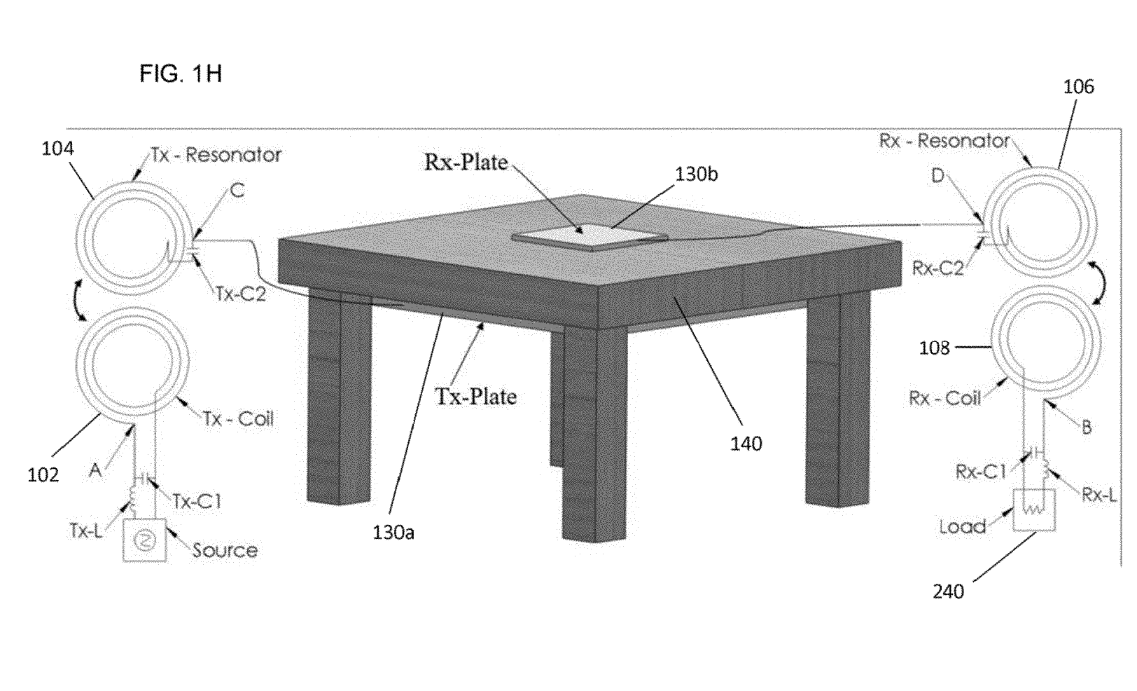

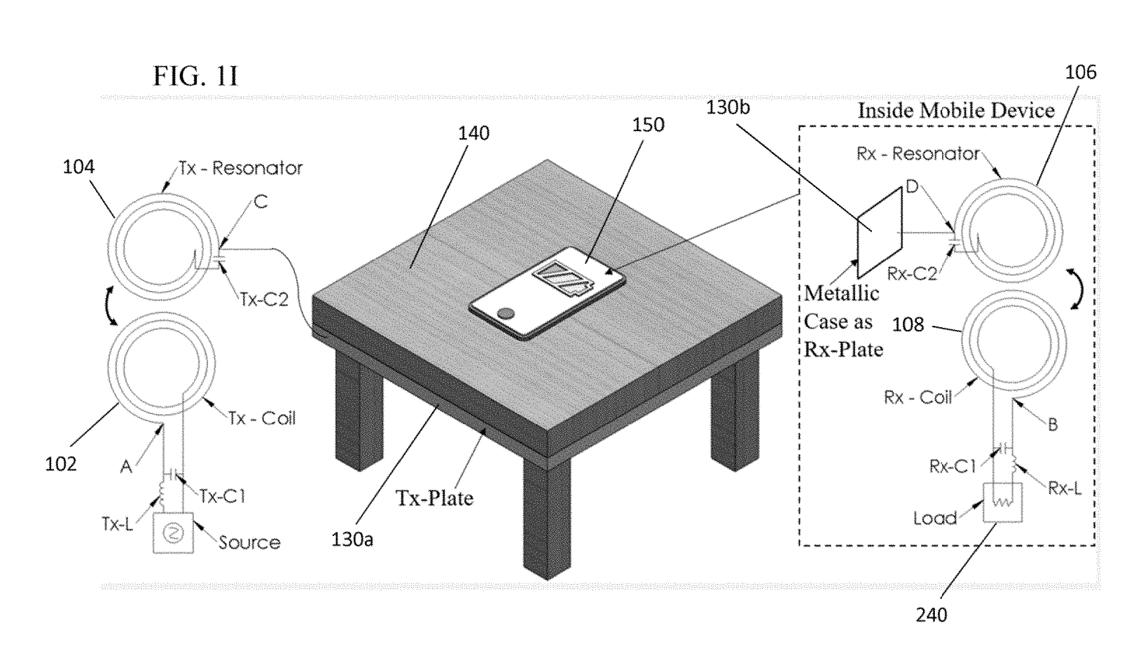

FIG. 1A shows an embodiment of a system 100, combining single-conductors and an electrical coupling method (or simply “electrical coupling”) between the transmitter and receiver sides of the system 100. In this embodiment, the single-ended and double-ended structures are implemented as coils. The system 100 comprises two pairs of coils: a transmitting pair (coils 102 and 104) and a receiving pair (coils 106 and 108). The transmitting pair is composed of a double-ended transmitter coil 102 inductively coupled to a single-ended coil 104. The receiving pair, analogously, comprises a single-ended coil 106 inductively coupled to a double-ended coil 108.

The electrical connection between the transmitter 104 and receiver 106 single-ended coils is established through the combination of single-conductors and an electrical coupling. Such an electrical coupling is exemplified, but is not limited, in FIGS. 1B-1G. For example, the electrical coupling can comprise parallel arbitrarily shaped conductors (FIG. 1B), capacitive plates (FIG. 1C), a new pair of inductively coupled coils (FIG. 1D), a series spacing (FIG. 1E), or a parallel spacing (FIG. 1F), between the transmitter single-conductor 118 and the receiver single-conductor 120. Additionally, more stages can be added to the system 100 as depicted of example in FIG. 1G, in which one or more electrical couplings can be added to the system 100 in a cascaded, series, or parallel form, such that the system 100 will have multiple stages. In the majority of the depicted embodiments, the electrical coupling comprises a reactive component. This means that the power is received through a single electrical conductor as opposed to using a pair of electrical conductors as in conventional systems. However, such single electrical conductors do not have the necessity of being electrically attached to the transmitter side, and rather have the possibility of using capacitive coupling, for instance, between the transmitter and receiver single-conductors. A “single electrical conductor” may comprise multiple electrical conductors electrically connected through short, resistive, capacitive or inductive coupling, thereby electrically acting as a single-conductor.

In the depicted example embodiments, the conducting structure is connected to the transmitter single-ended coil 104 at only a first single connection point 110 and to the receiver side single-ended coil 106 at only a second single connection point 112. The conducting structure is composed of the transmitter single-conductor 118 electrically connected to the electrical coupling 132—such as a transmitter capacitive plate 130a (FIG. 1C)—through the point 114. The receiver single-conductor 120, through the connection 116, is attached to the electrical coupling such as a receiver capacitive plate 130b (FIG. 1C).

All the components of the proposed system 100 resonate together at a desired frequency. In order to accomplish this, additional components (not depicted) may be used to match and tune the system to the desired frequency. For instance, one or more capacitors may be added between points 122 and 110 in order to adjust the coil 104 electrical length. Similarly, one or more capacitors may be added on the receiver side between the points 124 and 112 to adjust the receiver single-ended coil 106. However, this matching and tuning technique is not limited to capacitors; in particular, one or more inductors, resistors, and/or any other reactive components may be used, in any configuration. Additionally, the matching and tuning networks of the single-ended coils 104 and 106 is not limited to a parallel connection between the points 122 and 110 (on the transmitter side), and the points 124 and 112 (on the receiver side); the matching and tuning network can be added to any desired part of the coils 104 and 106, including a series configuration at any point in the coils 104 and 106. Furthermore, such matching and tuning networks may have a constant or variable reactance, which may be managed by a microcontroller or a control circuit. Additionally, series capacitors may be added to the coils 104 and 106 to tune the system 100 as required. In different embodiments (not depicted), the matching and tuning capacitors of the single-ended coils 104 and 106 may comprise multiple capacitances comprising a series, parallel, or hybrid series/parallel network. Additionally, in other embodiments (not depicted), inductors and/or resistors may be used in any configuration, such as π and T networks, in order to match and tune the system 100. Finally, in the depicted embodiments, the single-ended coils 104 and 106 both comprise have one end left floating, 122 and 124 for the transmitter and receiver coils, respectively. When the entire system is built to resonate at the desired frequency, the matching and tuning networks may not be necessary.

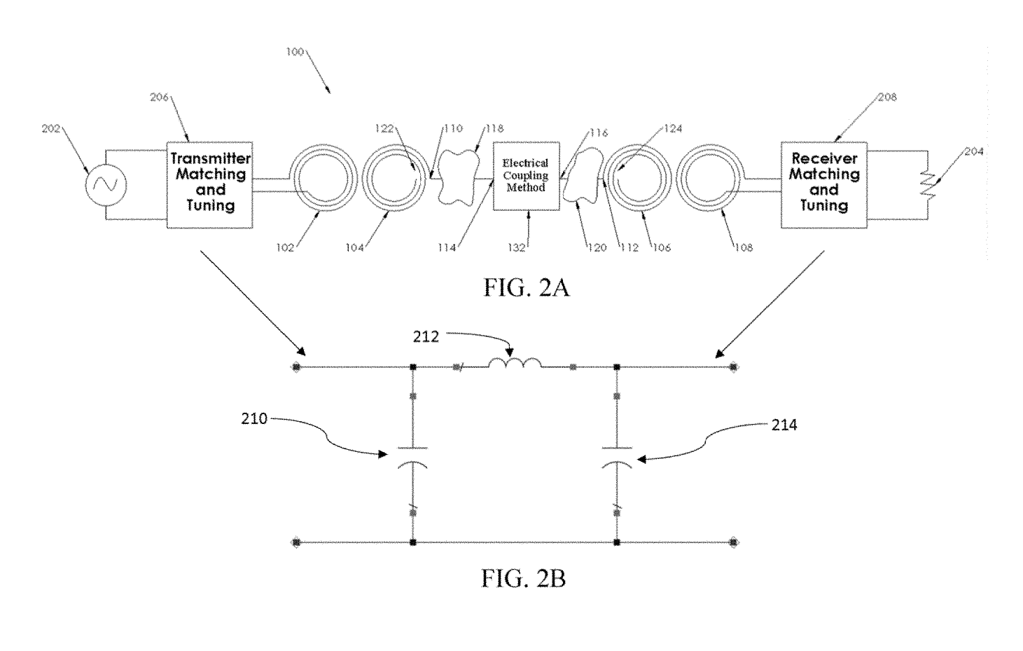

FIG. 1H shows one embodiment of the system 100 used in conjunction with a table 140. In this embodiment, the transmitter capacitive plate 130a is positioned along the underside of the table 140, whereas the receiver capacitive plate 130b is positioned upon an upper side of the table 140. This setup may be useful for recharging a user's mobile device, for example. Specifically, a user may inductively couple their mobile device (comprising the load 204 (shown in FIGS. 2A-2B) and the double-ended coil 108) to the receiver single-ended coil 106. Through the coupling of capacitive plates 130a and 103b, power may be transferred from the power source 202 (shown in FIGS. 2A-2B) to the load 204.

FIG. 1I shows another embodiment of the system 100 used in conjunction with a table 140. In this embodiment, as in FIG. 1H, the transmitter capacitive plate 130a is positioned along the underside of the table 140. However, unlike FIG. 1H, the receiver capacitive plate 130b comprises a metallic case of the mobile device 150. A user may inductively couple their mobile device 150 (comprising the load 204 (shown in FIGS. 2A-2B), the double-ended coil 108, the receiver single-ended coil 106, and the receiver capacitive plate 130b) to the transmitter capacitive plate 130a. Through the coupling of capacitive plates 130a and 103b, power may be transferred from the power source 202 (shown in FIGS. 2A-2B) to the mobile device 150.

The double-ended coils 102 and 108 may require matching and tuning in order to increase their efficiency at the desired frequency. In FIGS. 2A-2B, matching and tuning networks 206 and 208, respectively in series with the transmitter and receiver double-ended coils 102 and 108, are responsible for tuning and matching of double-ended coils 102 and 108. Matching and tuning networks 206 and 208 may contain multiple capacitors in a variety of arrangements, and may be used with one or more inductors, resistors and/or capacitors, in any configuration, such as π or T configurations. Additionally, such matching and tuning networks 206 and 208 may have a constant or variable reactance, which may be managed by a microcontroller or a control circuit.

The load 204 is depicted as being completely resistive in FIGS. 2A-2B. However, the load 204 may comprise a non-zero reactance, or may include for example a rectifier and regulator circuit to transform the received power into continuous voltage and current. The receiver matching and tuning network 208 may transform the impedance of the load 204 and match the impedance to the impedance of the system 100. Additionally, the receiver matching and tuning network 208 may be changed in order to alter the power received at the load 204 to a desired value.

The receiver module of the system 100 may contain a rectifier or AC-DC converter responsible for adapting the received alternating current (AC) to direct current (DC). The rectifier may comprise a half-bridge, full-wave or full-bridge topology, as well as a class D or class E resonant configuration. The rectifier may use diodes with a low forward voltage drop, such as Schottky diodes, especially those with low or zero reverse recovery time (silicon carbide Schottky diodes) to minimize the losses and maximize the AC to DC power conversion efficiency. The AC-DC converter may also contain an input matching network for ensuring the best point of operation, as well as inductive and capacitive filters to remove fluctuations in the output current or voltage.

The AC power source 202 generates the power for delivery to the load 204, at the desired frequency, through the system 100. The power source 202 may be included in some embodiments of this invention. The power source 202 may be comprise an oscillator connected to an amplifier. The amplifier may comprise a class D or class E amplifier operating at the condition of ZVS (Zero Voltage Switching) or ZCS (Zero Current Switching). Such amplifiers comprise a switching converter, a tank circuit comprising inductors and capacitors to match the ZVS or ZCS conditions, and a resonant load. Thus, the output terminals of the power source 202 are connected to the transmitter matching and tuning network 206, or directly to the transmitter coil 102.

### Circuit Model

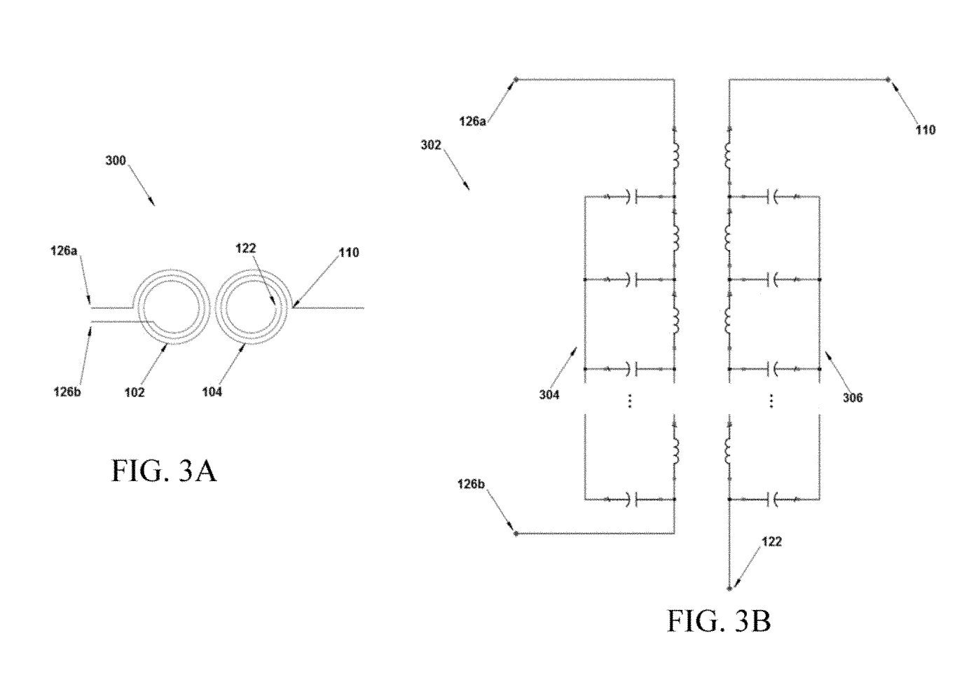

FIG. 3A shows an embodiment of a system 300 which is the combination of a double-ended coil 102 inductively coupled to a single-ended coil 104 as originally shown in FIG. 1A. FIG. 3B shows a circuit diagram model 302 for system 300, wherein the circuit model 304 corresponds to the double-ended coil 102 and the circuit model 306 corresponds to the single-ended coil 104. Since the coils 102 and 104 have a length comparable to the wavelength at the frequency of operation, a distributed model may be developed to accurately represent the circuit 302. Each infinitesimal circuit length is represented by a series inductance and a shunt capacitor. The overall combination of these inductances and capacitances determines the resonating frequency of the pair of coils 102 and 104. Series resistances and shunt conductances are omitted in the diagram, but can be used to represent losses in the system 300.

While this model is shown as an example for coils 102 and 104, the same model is also valid for the coils 106 and 108 or any other similar combination of coils.

### Measurement Methods

### Impedance Parameters

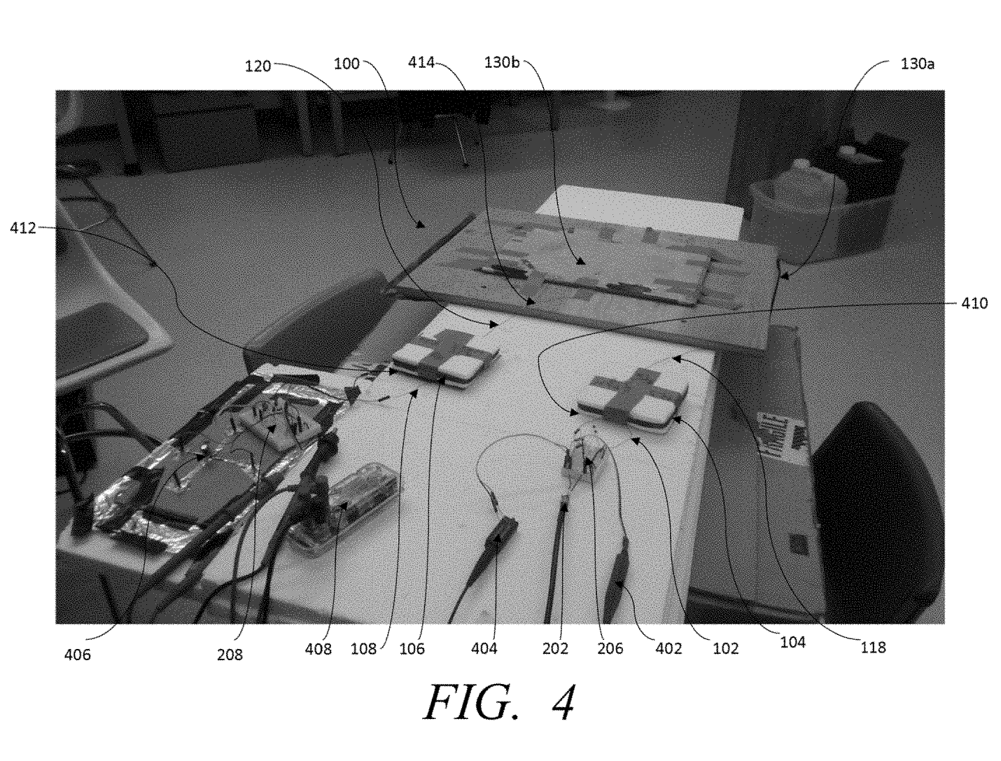

Measurements of the Z-parameters of the input of the system 100 (between the points 126a and 126b) were performed using a Tektronix™ DPO 710604C oscilloscope. Direct measurements of the input current and voltage were obtained with a Ct-2 current probe 404 and a P6248 differential voltage probe 402, respectively (see FIG. 4). With the oscilloscope, it was possible to acquire the phase difference between the current and voltage signals. With these three values (current, voltage and phase), it was possible to calculate the input impedance of the circuit at a certain frequency.

### Scattering Parameters

Measurements of the 2-port S-parameters of the system 100 used points 126a and 126b as port 1 (or the input port), and points 128a and 128b as port 2 (or the output port). The measurements were obtained with a Rohde and Schwartz™ ZVL13 vector network analyzer, calibrated with the SOLT (short-open-load-thru) method. To perform the measurements on the VNA, transformers with a 1:1 turn ratio were added to both the input and the output of the system. This method reduces or eliminates parasitic currents that may be induced on the outer shield of the coaxial cables attached to the VNA and, therefore, reduces or eliminates possible perturbations in the electromagnetic field distribution and in the measurements. The effect of these transformers was de-embedded in the results provided in this disclosure.

### Efficiency

In order to measure the output voltage of the system 100, a rectifier 406 was added between the points 128a and 128b of the receiver double-ended coil 108, before the load 204. Subsequently, the DC output current and voltage were measured with a Mooshimeter™ multimeter 408. The efficiency was calculated by comparing the value of DC output power with the input power.

Single-Conductor with Capacitive Power Transmission

FIG. 4 shows an example of the system 100. In this case, both transmitter and receiver single-conductors (118 and 120, respectively) are implemented as wires. The transmitter capacitive plate 130a is in the form of an aluminium sheet of 54.1 cm by 36.4 cm, and the receiver capacitive plate 130b is a copper sheet of 30.7 cm by 23 cm, standing 3 cm away from the transmitter capacitive plate 130a.

The transmitter and receiver double-ended and single-ended structures are implemented as coils in this example. Both double-ended coils 102 and 108 are 10 cm×10 cm square coils, with 3 turns of 24 AWG Polyamide-coated magnet wire. The single-ended coils 104 and 106 are 10 cm×10 cm square coils, with 14 turns of 24 AWG Polyamide-coated magnet wire. Each pair of double-ended and single-ended coils is built around the same core.

The total wavelength of the single-ended coils 104 and 106, added to the single-conductors 118 and 120 and capacitive plates 130a and 130b, is about 11.2 m, which is close to a quarter wavelength at 6.78 MHz—a quarter wavelength would be 11 m at this frequency. Matching and tuning networks 206 and 208 were added on both the transmitter and receiver sides (corresponding to 206 and 208, respectively), in order to improve the efficiency of the system 100 by adjusting its resonant frequency to the desired frequency. FIG. 2B shows one possible example of input and output matching and tuning networks 206 and 208. Additionally, a fine tuning of the resonant frequency can be performed by the inclusion of capacitors between the two ends of each single-ended coil—between points 122 and 110 for the transmitter coil 104, and points 124 and 112 for the receiver coil 106.

Moreover, measurements were taken when varying the number of turns of the double-ended coils 102 and 108 and when varying the gap between the capacitive plates 130a and 130b, for comparison with the previously described coils. These additional coils used different values for the matching and tuning network.

### Communication Signals

The communication measurements were performed using a signal generator at the input of the system 100. The generator was powered with a battery and an inverter, in order to guarantee that the transmitter and receiver grounds were isolated from each other. The received signal was measured with a Tektronix™ DPO 710604C oscilloscope, using a P6248 differential voltage probe 402, after the matching of the system 100 using receiver matching and tuning network 208.

### Results

The setup depicted in FIG. 4 was tested with several combinations of coils. Firstly, wrapped single-ended coils 104 and 106 with a constant quantity of 14 turns were tested by varying the number of turns on the double-ended coils 102 and 108 from six to three turns (the number of turns was changed simultaneously on the transmitter and receiver coils). For simplification, in all cases the matching and tuning networks were established using an L-configuration. Table 1 provides the values used to match each set of coils to the desired frequency.

TABLE 1
Matching and tuning networks used for each coil.

| MATCHING | COIL | | | |
|---|---|---|---|---|
| COMPONENT | 14:06 turns | 14:05 turns | 14:04 turns | 14:03 turns |

INPUT

| | | | | |
|---|---|---|---|---|
| 210 | — | — | — | — |
| 212 | 2680 nH | 1330 nH | 2500 nH | 2660 nH |
| 214 | 168 pF | 288 pF | 194 pF | 100 pF |

OUTPUT

| | | | | |
|---|---|---|---|---|
| 210 | 20 pF | 32 pF | 57 pF | 100 pF |
| 212 | 14700 nH | 12850 nH | 10330 nH | 1825 nH |
| 214 | — | — | — | — |

In these cases, there were no plates attached to the open ends of the single-ended coils (i.e. points 410 and 412 were not used during these measurements). In addition, the single-conductor 120 on the receiver side was not divided into three wires at point 414—the single-conductor 120 was a simple wire going from the receiver capacitive plate 130b to the single-ended receiver coil 106.

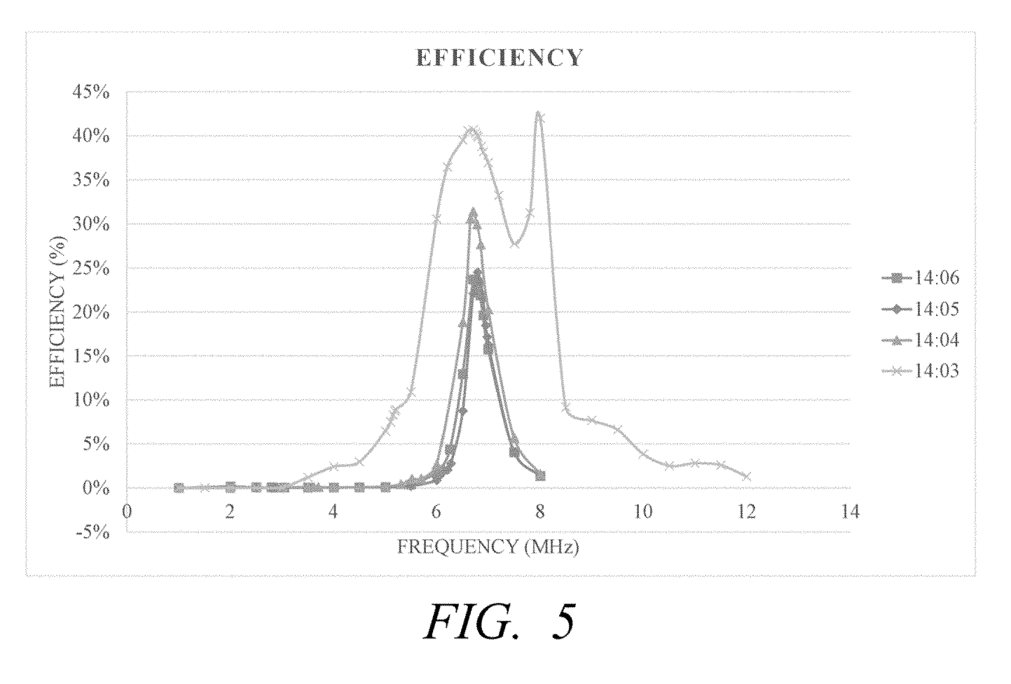

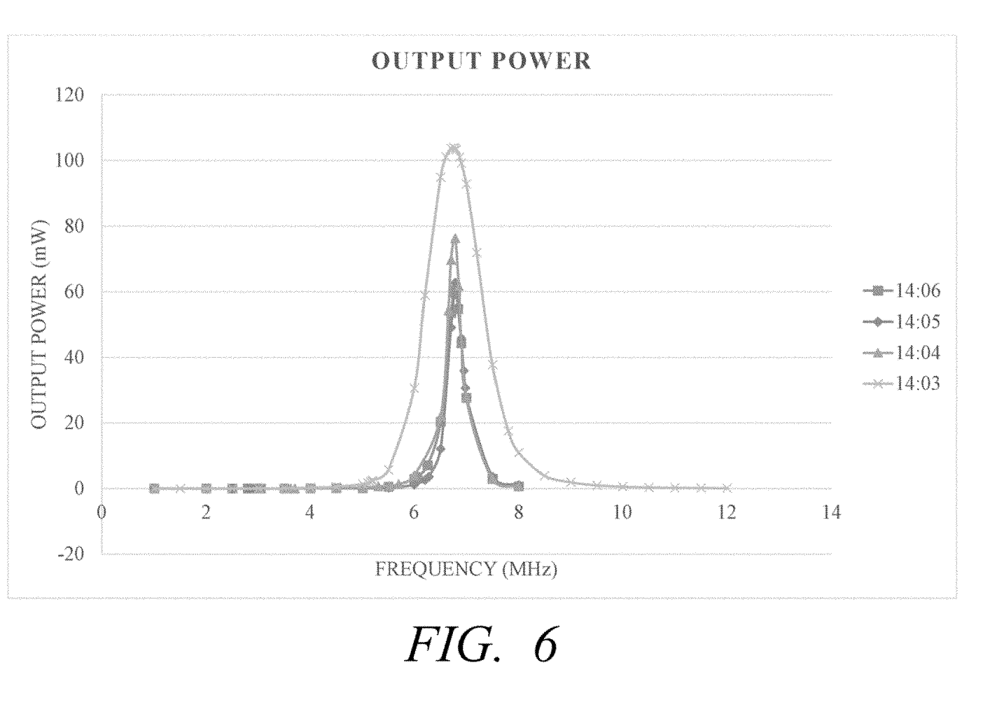

FIG. 5 is a graph of the efficiency of each of these pairs of single-ended and double-ended coils with, respectively, 14 and 6 turns, 14 and 5 turns, 14 and 4 turns, and 14 and 3 turns. It is possible to see that the best performance was obtained with 3 turns on the double-ended coils 102 and 108. Additionally, after matching, all pairs of coils were able to resonate properly at the desired frequency. Although 3 turns at the double-ended coils 102 and 108 provides high efficiency in frequencies other than 6.78 MHz, the output power is significantly diminished at these other frequencies, as can be seen in FIG. 6. Such measurements include the losses in the matching and tuning networks 206 and 208, and in the rectifier 406. At this level of power, the efficiency of the rectifier 406 was 65%. This means that for double-ended coils 102 and 108 with 3 turns, the efficiency of the system 100 added to the matching and tuning networks 206 and 208 would be about 63%.

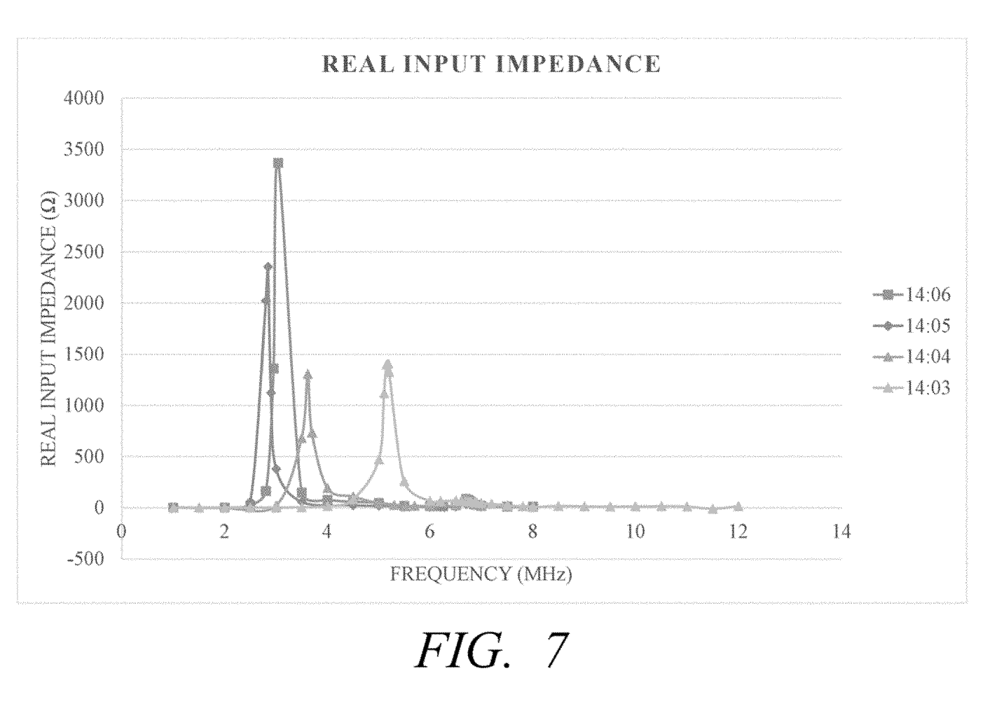

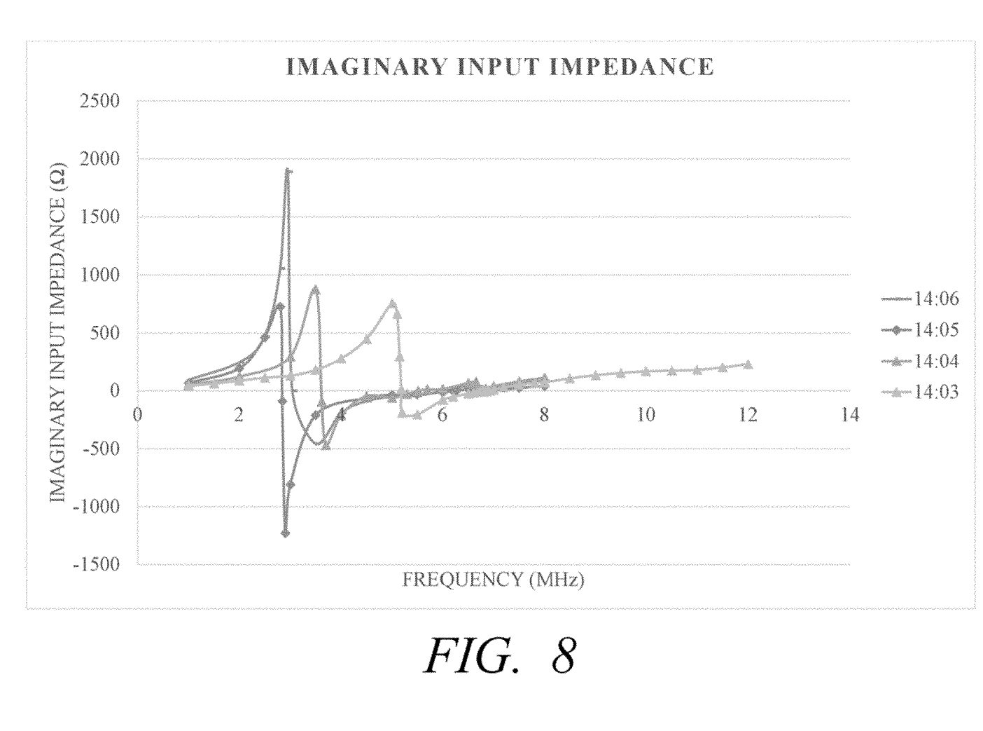

FIGS. 7 and 8 are graphs showing the input impedance of the system 100, measured between the power source 202 and the transmitter matching and tuning network 206. The impedance was matched to 50Ω at a frequency of 6.78 MHz, which was the output impedance of the generator used in these tests. However, this generator could have been substituted for any suitable power source, with any suitable impedance; the matching would have been adjusted for other such cases.

Since the single-ended coils 104 and 106 with 14 turns and the double-ended coils 102 and 108 with 3 turns showed the best results in the previous tests, these same coils were chosen for the following experiments.

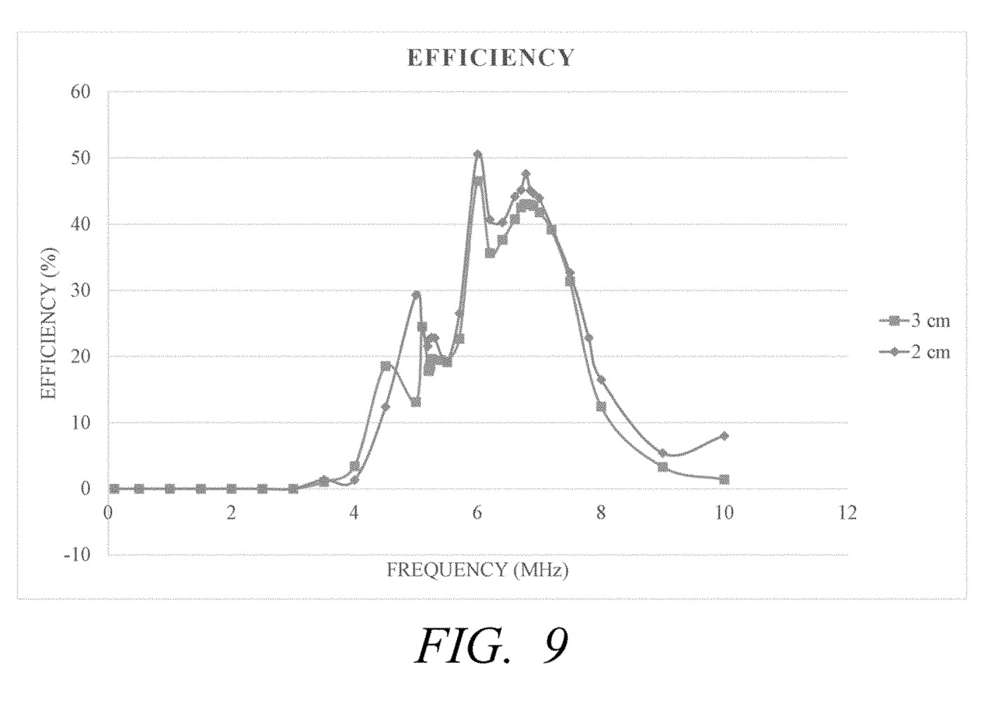

Copper plates 410 and 412 were added to the floating ends 122 and 124 of the single-ended coils 104 and 106, in order to increase their electrical length and bring the system's resonance closer to 6.78 MHz. Additionally, at the point 414, the receiver single-conductor 120 was divided into three wires shorted together, thereby forming the receiver single-conductor 120, having the same purpose as the copper plates 410 and 412. These additions to the system 100 were able to increase the efficiency of the same coils up to 3% at the desired frequency, as can be seen in FIG. 9. In addition, to take into account the modifications to the system 100, the matching was changed, as can be seen in Table 2 below.

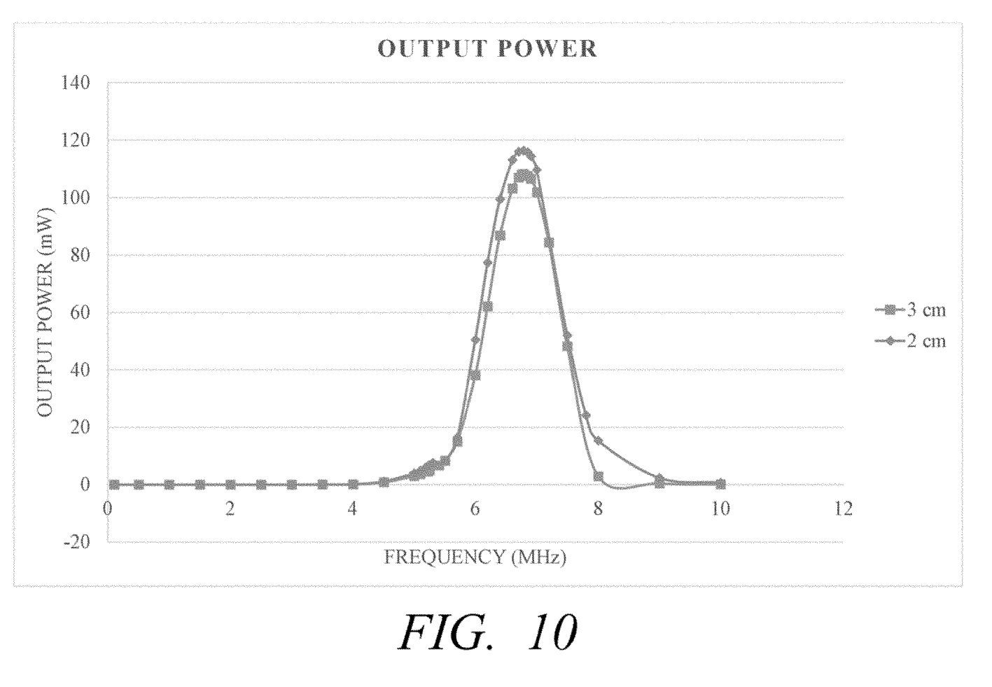

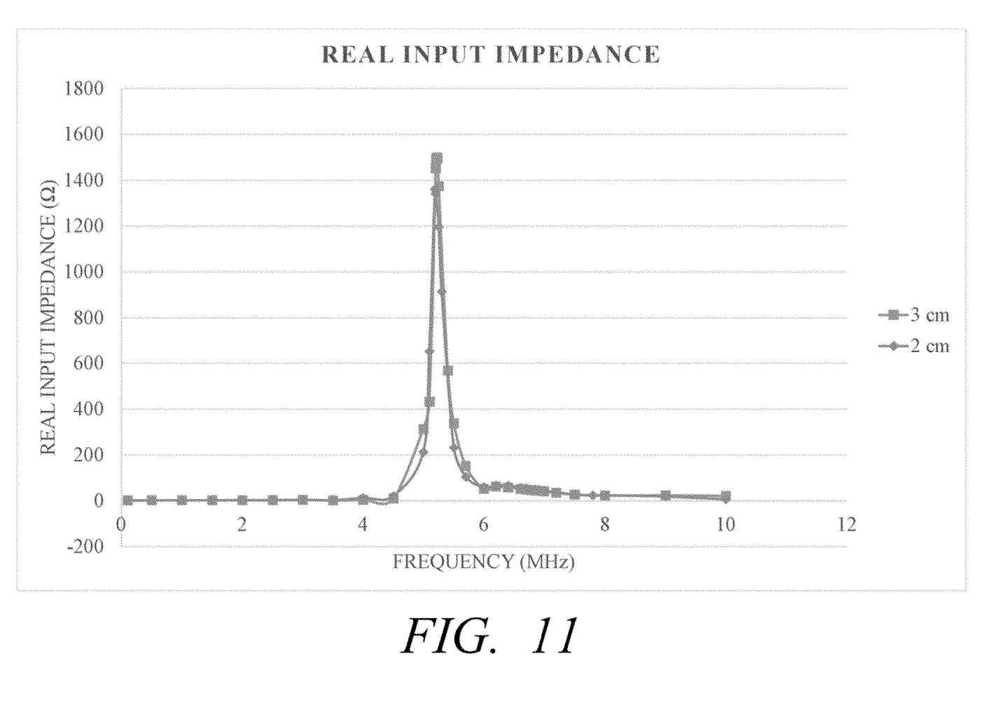

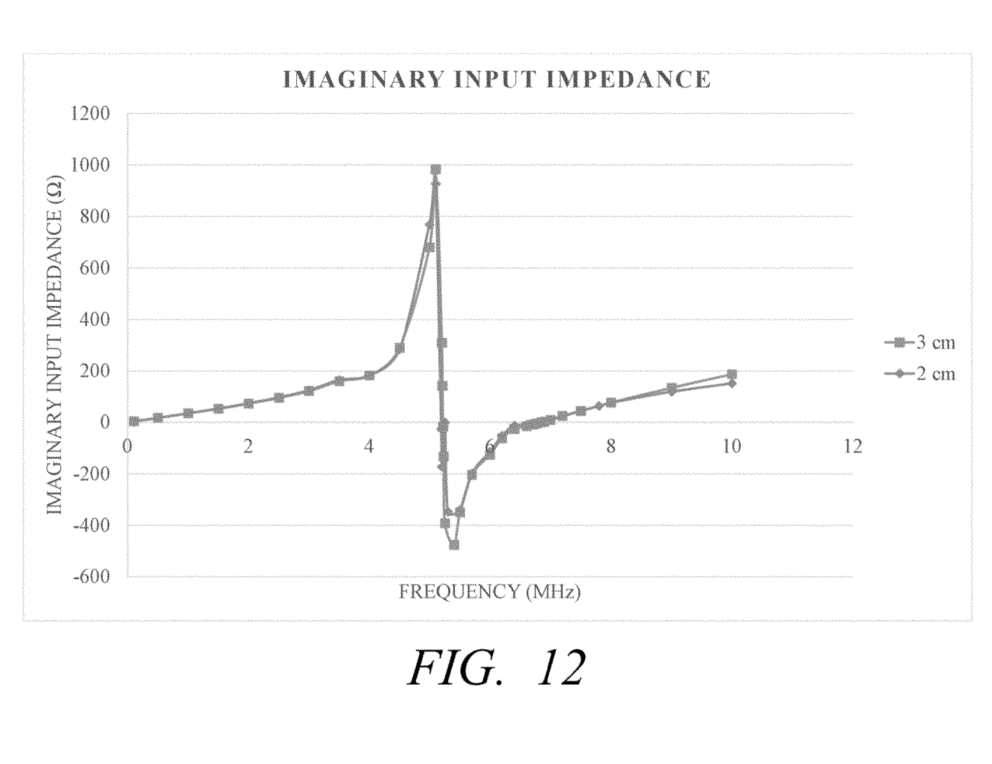

Furthermore, the distance between the capacitor plates 130a and 130b was changed to 2 cm in order to analyze its impact on system efficiency. FIG. 9 illustrates that a change of 1 cm in the distance between the capacitor plates 130a and 130b resulted in an increase in the efficiency of the system 100 by about 5%, in turn resulting in an additional 10 mW at the output, as can be seen in FIG. 10. The input impedances for the cases with 3 cm and 2 cm spacing between the capacitor plates 130a and 130b are presented in FIG. 11 and FIG. 12.

TABLE 2
Matching and tuning networks for coil with best efficiency.

| | |
|---|---|
| MATCHING | COIL |
| COMPONENT | WITH 14:3 TURNS |

INPUT

| | | |
|---|---|---|
| 210 | — | 517 pF |
| 212 | 2220 nH | 100 nH |
| 214 | 115 pF | 660 pF |

OUTPUT

| | | |
|---|---|---|
| 210 | 79 pF | — |
| 212 | 2990 nH | 1940 nH |
| 214 | — | — |

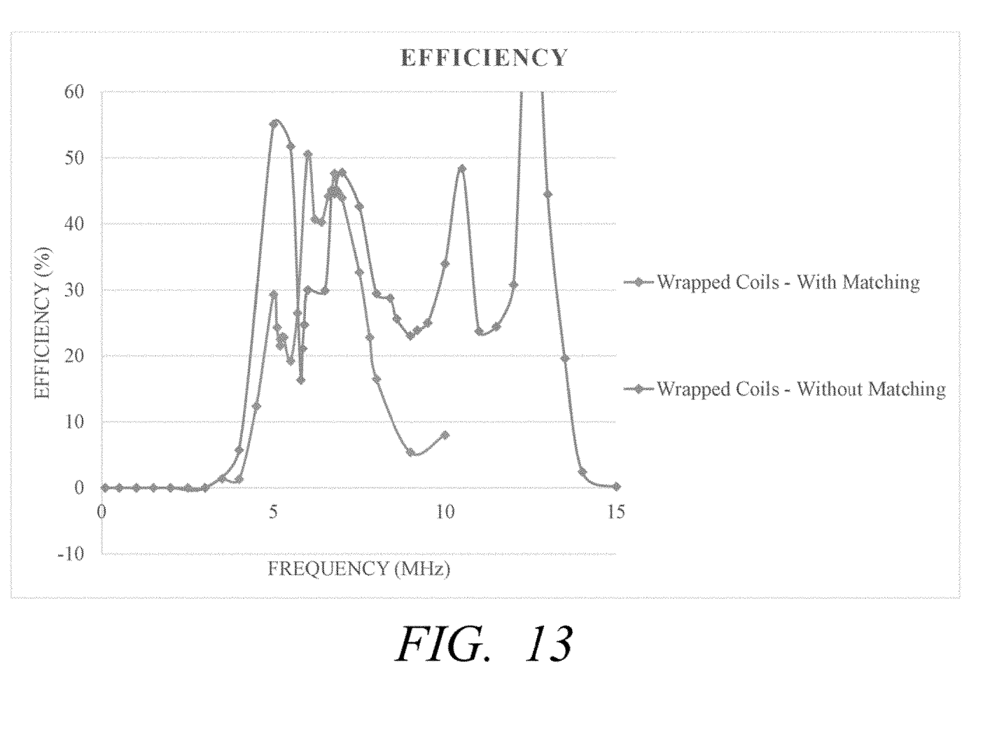

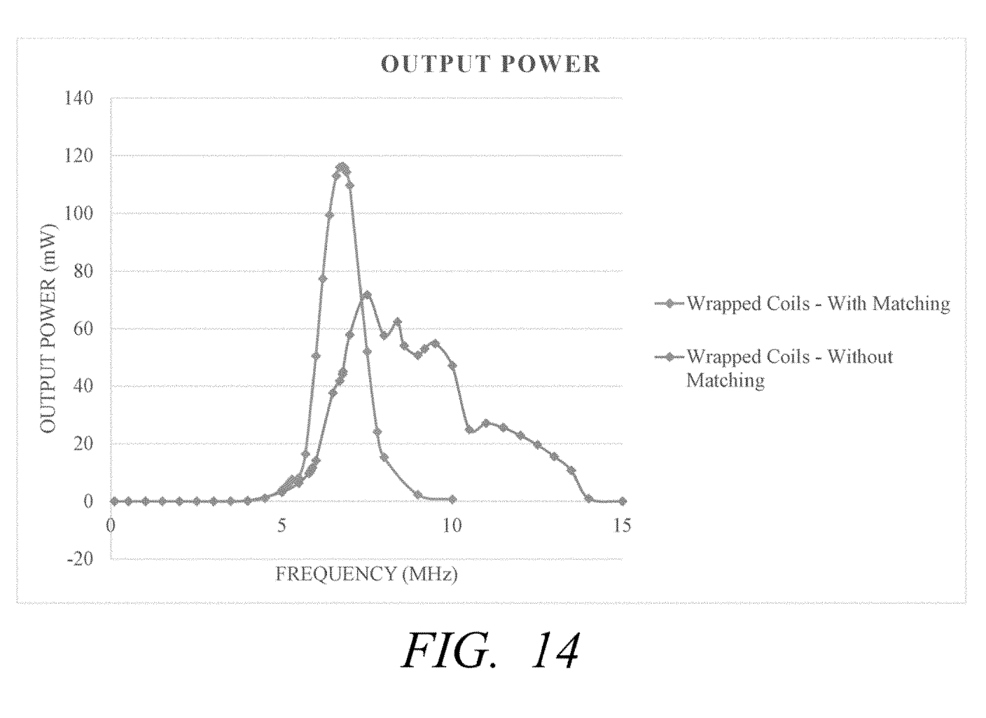

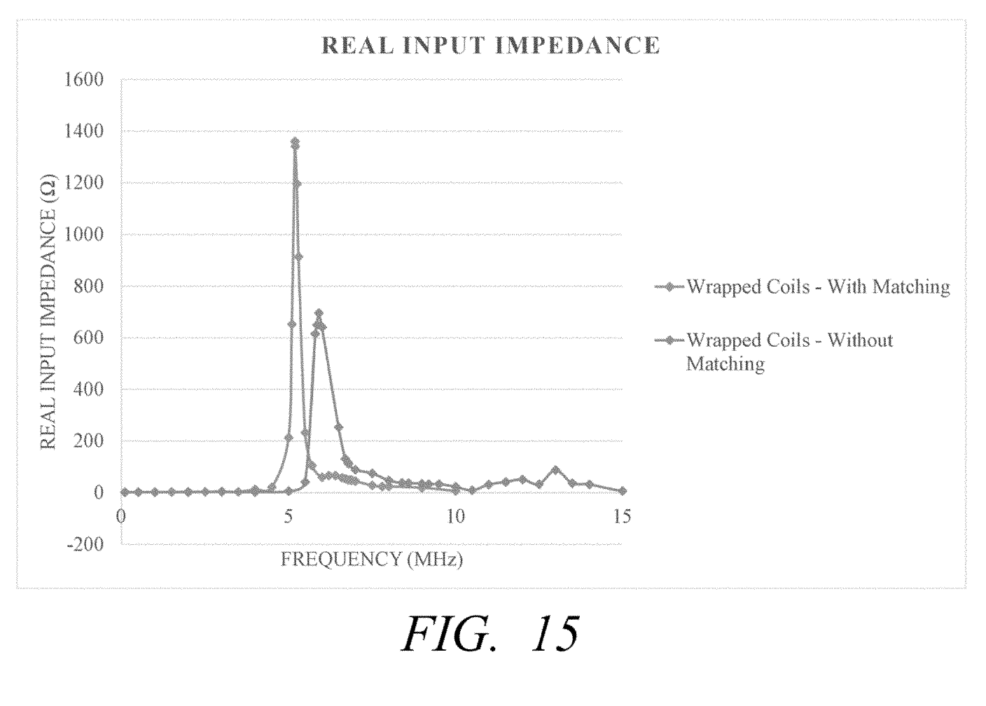

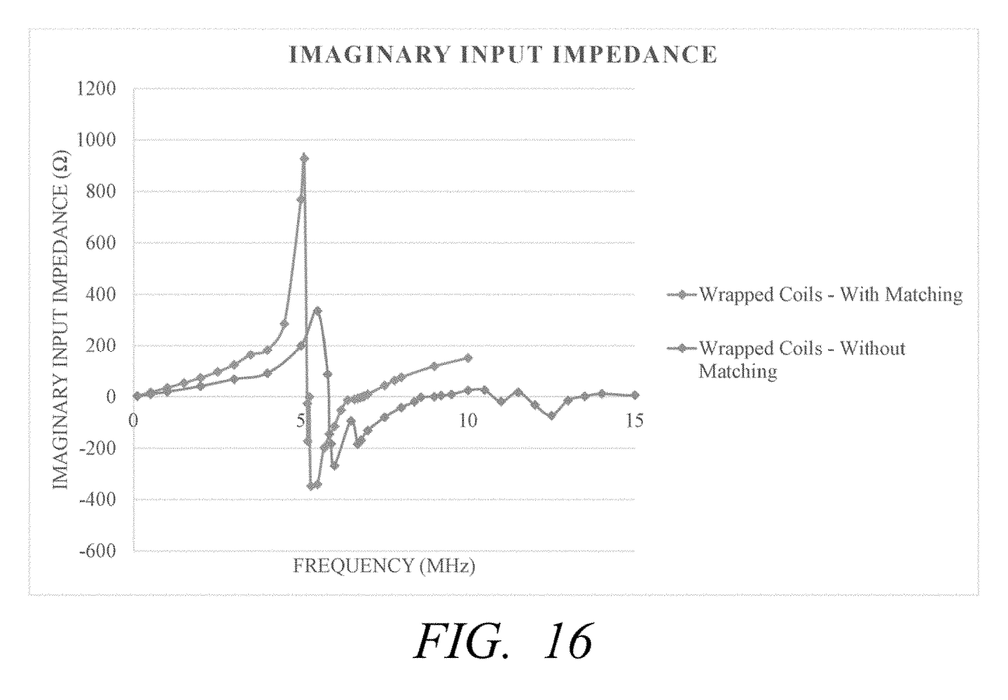

FIG. 13 presents the comparison between the best-shown wrapped coils with and without the matching and tuning networks 206 and 208. One can see that the efficiency of the system 100 does not increase drastically with matching at the frequency of 6.78 MHz, since the system 100 is already designed to resonate at this frequency. However, the addition of matching and tuning networks 206 and 208 allows for significant increase in the output power of the system, as seen in FIG. 14, due to fewer reflections caused by the difference of the impedances between the system 100 and the power source 202, and between the system 100 and the load 204 (in this case represented as the rectifier 406). FIGS. 15 and 16 present the input impedance of the system 100, showing that the input impedance is adjusted to 50Ω when the matching and tuning networks 206 and 208 are included in the system 100.

The best measured efficiency for the wrapped coils is 43.05%. Disregarding the 65% efficiency of the rectifier 406, the overall efficiency of the system 100 is 66.22%. However, this value still includes the losses in the matching and tuning networks 206 and 208, which can be improved.

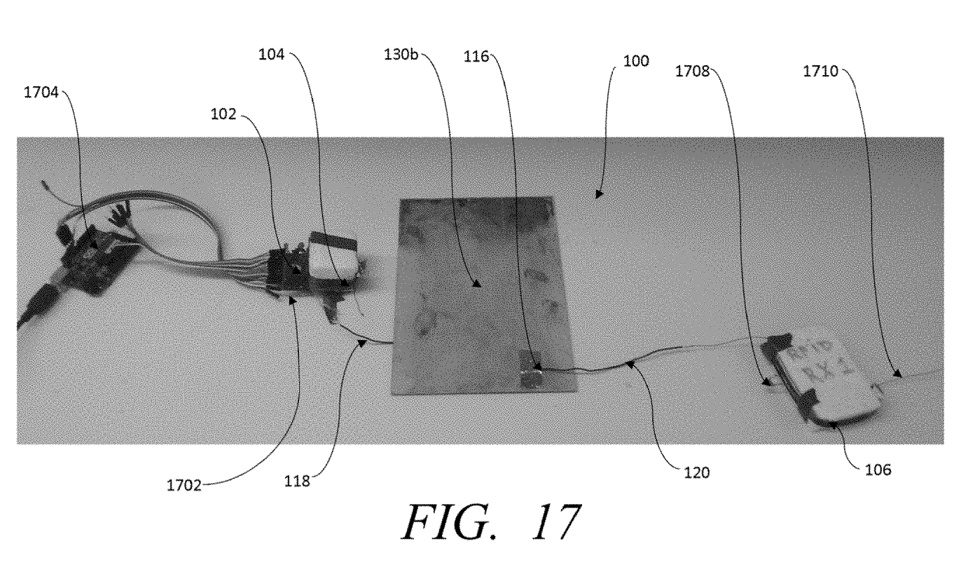

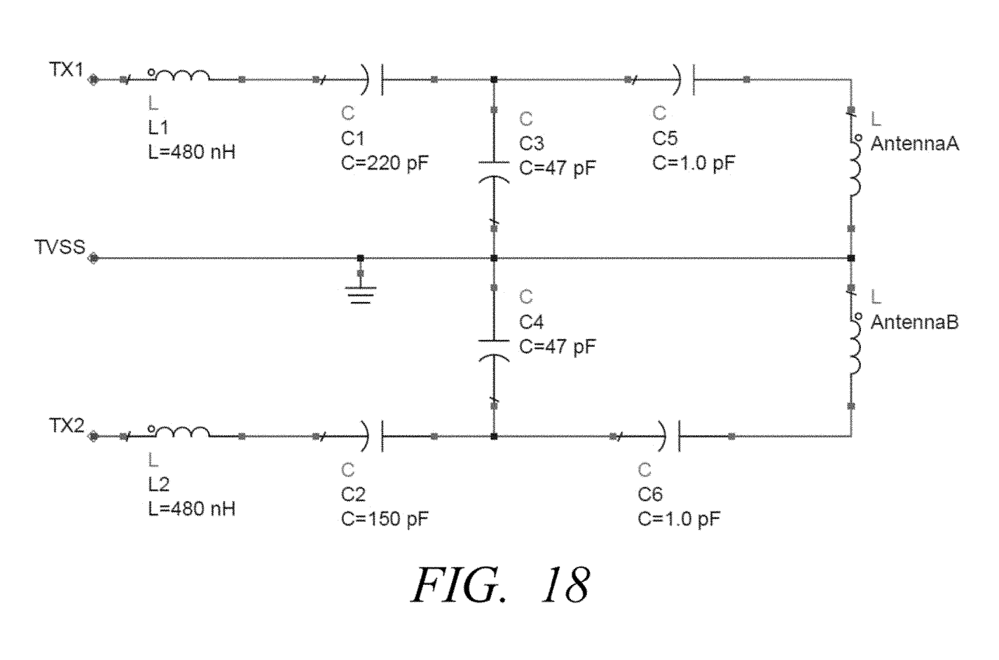

FIG. 17 demonstrates that the system 100 is able to transfer power and data over the metallic structure. In this case, a commercial system for RFID tag measurement was adjusted in order to be used in the system. The RFID system used a MFRC522 chip controlled by a microcontroller 1704 and transmitted data over the system. An existing RFID reader 1702 had its matching of the coil modified to a frequency of 13.56 MHz, in order to be compatible with the system. The transmitting coil 102 coupled to a 4 cm×4 cm coil 104 made with 28 turns of 24 AWG wire. FIG. 18 shows the matching of the double-ended coil 102, which is a modified version of the corresponding coil in the original system and used components with higher quality factors. The transmitter single-ended coil 104 was then attached to a single-conductor 118 which was connected to the transmitter capacitive plate 130a (not visible in FIG. 18). The receiver capacitive plate 130b was positioned with 0.8 mm of spacing between the plates. The receiver capacitive plate 130b was then attached to the receiver single-conductor 120 electrically connected to the receiver single-ended coil 106. Both plates 130a and 130b were copper sheets with surface areas of 22.86 cm×15.24 cm. The dielectric between the plates 130a and 130b was FR4. The receiver single-ended coil 106 was a 5 cm×8.5 cm rectangular coil with a 10 pF series capacitor 1708 in the middle of the coil 106, used for tuning. An additional length of wire 1710 may be connected to the open end 124 of the single-ended coil 106 to adjust the resonating frequency of the system. The double-ended receiver coil 108 was an RFID tag (not depicted) placed on top of the receiver single-ended coil 106.

### Communication

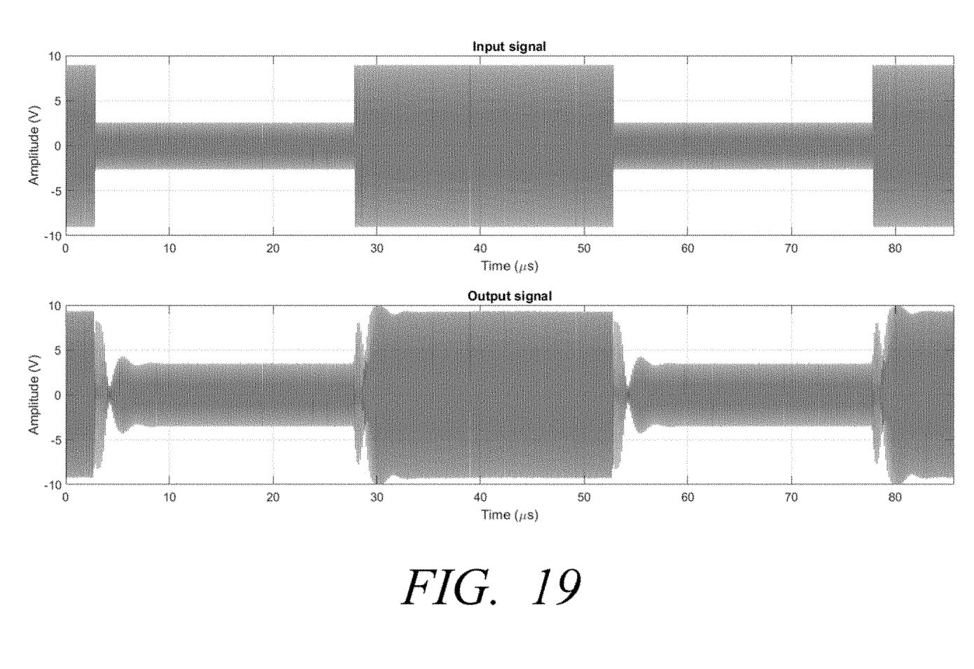

FIG. 19 shows how the power signal can be modified to carry a communication signal. In this particular embodiment, the power signal of 6.78 MHz applied to the system 100 was used as a carrier signal for a digital signal modulated according to an ASK modulation scheme (Amplitude Shift Keying), at a data rate of 20 kHz. When the amplitude of the signal envelope is reduced, this state can represent an information bit ‘1’, whereas a bit ‘0’ corresponds to the envelope at maximum amplitude, for instance. While ASK modulation was used in the foregoing embodiment, in alternative embodiments any suitable type of digital or analog data modulation may be used, including any type of source/channel coding for the data. In the example presented in FIG. 19, no matching and tuning networks 206 and 208 were used.

### Variations on the Design

In what follows, specific details of various components of systems are described. However, as will be recognized by a person skilled in the art, variations to the components and to the systems may be made without departing from the scope of the disclosure. As a non-limiting example, where a component is said to have a particular value, or where a coil is said to comprise a specific number of turns, such a value or such a number of turns is merely representative of one particular way of implementing the methods described herein—the skilled person will recognize that other values may be used, or other numbers of coils may be used, without departing from the scope of the disclosure.

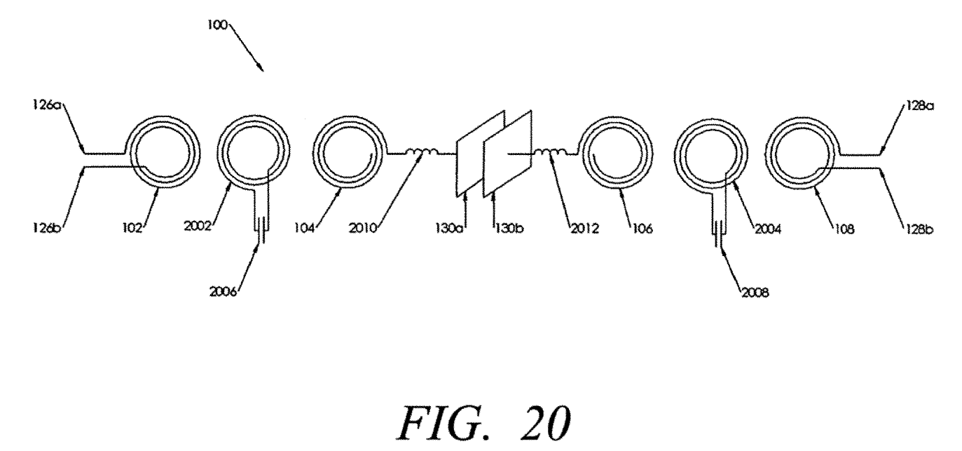

FIG. 20 demonstrates another embodiment of system 100, this time using an additional resonator on each side of the system 100. Planar single-ended coils 104 and 106 were provided in single layers of FR4 substrate, each with 13 turns, an inner diameter of 64 mm, a trace width of 1.29 mm, and a radius variation of 3 mm between successive turns. On the other layer of the substrate of the transmit-side were provided two coils: (1) coil 102 implemented as a single-loop coil with a diameter of 100 mm, and a trace width of 1.29 mm, without any matching or tuning circuit attached to it; and (2) an additional inductive coupling stage between coil 102 and coil 104, represented as a loop coil 2002, with a diameter of 120 mm, and a trace width of 1.29 mm, using a parallel capacitor 2006 of 1 nF. On the other layer of the substrate of the receive-side were provided two coils: (1) coil 108 represented as a one loop coil with a diameter of 100 mm, and a trace width of 1.29 mm, without any matching or tuning circuit attached to it; and (2) an additional inductive coupling stage between coil 106 and coil 108, represented as a loop coil 2004, with a diameter of 120 mm, and a trace width of 1.29 mm, using a parallel capacitor 2008 of 1 nF.

The transmitter single-ended coil 104 was then attached to a single-conductor which was connected to the transmitter capacitive plate 130a. The receiver capacitive plate 130b was positioned to have 5 mm of spacing between the plates. The receiver capacitive plate 130b was then attached to the receiver single-conductor electrically connected to the receiver single-ended coil 106. Both plates 130a and 130b were copper sheets with surface areas of 30 cm×30 cm. The dielectric between the plates 130a and 130b was air. This system was built to work at 6.78 MHz. Therefore, additional compensation inductors 2010 and 2012 were added to each side of the system in order to compensate for the high reactance created by the capacitive plates 130a and 130b. Both inductors had values equal to 39 pH.

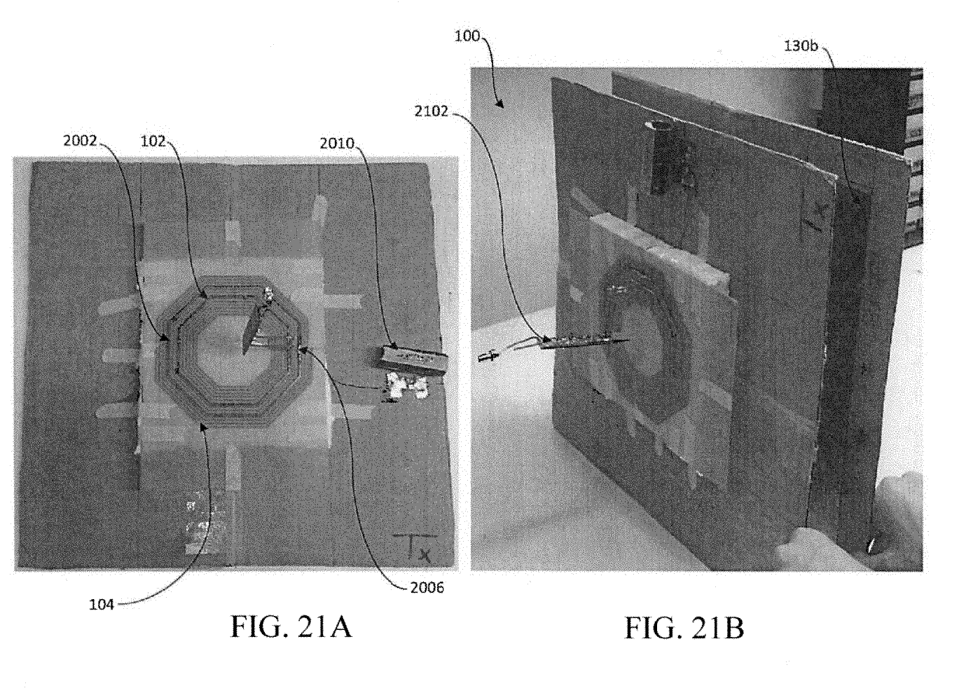

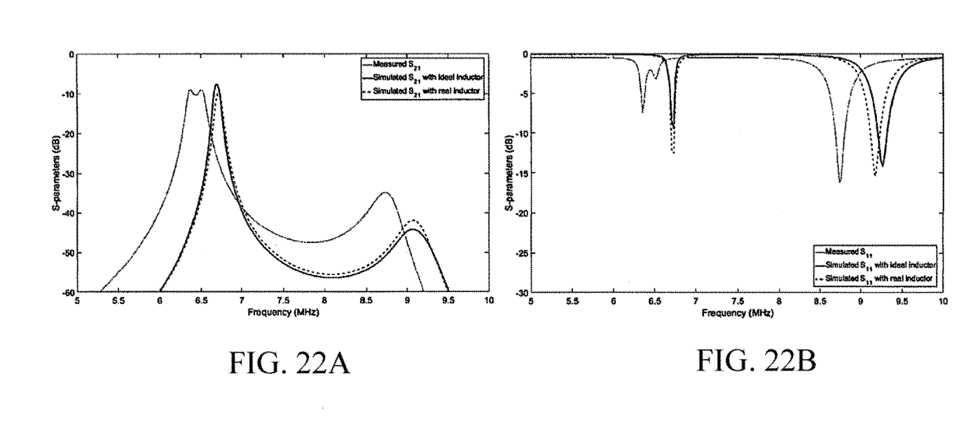

The implementation of the embodiment described in FIG. 20 is shown in FIGS. 21A and 21B. FIGS. 21A and 21B mostly show the transmit-side of the system, since the receiver has the same configuration. Additionally, FIG. 21B shows the 1:1 transformer 2102 used to obtain the S-parameters in FIGS. 22A and 22B.

FIGS. 22A and 22B show the simulation and measurement results of S11 and S21, respectively, for the embodiment presented in FIGS. 20, 21A and 21B. For the simulation results with an ideal inductor, at a frequency of 6.70 MHz, there is a peak of S21=−7.66 dB and a corresponding S11=−8.37 dB. For the simulation results with a real inductor with an equivalent series resistance of 6.9 Ohm, at a frequency of 6.70 MHz, there is a peak of S21=−9.50 dB and a corresponding S11=−12.1 dB. For the measurement results with an inductor with equivalent series resistance of 6.9 Ohm, at a frequency of 6.38 MHz, there is a peak of S21=−8.94 dB and a corresponding S11=−7.44 dB. Additionally, peaks of S21=−8.97 dB and S11=−3.19 dB exist at a frequency of 6.52 MHz.

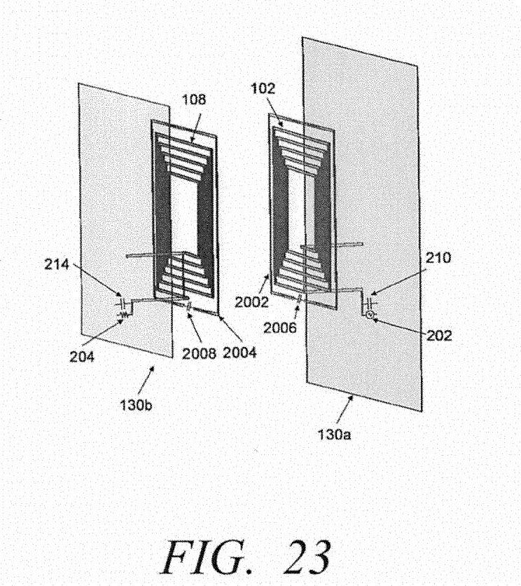

FIG. 23 demonstrates another embodiment of system 100, using both electric and magnetic couplings. The system functions based on a resonance which comes from coupled coils 102, 2002, 2004, and 108, and capacitors comprising plates 130a and 130b, coil 102 and plate 130a, and coil 108 and plate 130b. The operating frequency is in the range of 80-300 kHz which is compatible with medium-power Qi chargers. On the transmitter side, the coil 102 is above the plate 130a and makes a short-ended transmission line that generates electromagnetic fields above the plate 130a and around the coil 102. A capacitor 210 is in parallel with the coil 102 and provides matching between the source 202 and coil 102. For fixed distances between coil 102 and plate 130a, and between coil 102 and coil 108, a fixed capacitor can be used. The resonator 2002 is coupled to coil 102 and resonates at the operating frequency when the receiver is on top of the transmitter. The resonant frequency of resonator 2002 can be adjusted by changing the value of capacitor 2006. On the receiver side, the coil 108 and plate 130b absorb electromagnetic fields and generate a current through a load 204. A capacitor 214 is in parallel with the coil 108 and provides matching between the load 204 and coil 108. The resonator 2004 is coupled to coil 108 and resonates at the same frequency as resonator 2002. The resonant frequency of resonator 2004 can be tuned by changing the value of capacitor 2008. The resonators 2002 and 2004 are used to extend the transmitter-receiver distances up to 40 millimeters, as expected for Qi chargers.

The system was operated at 165 kHz. The coils and resonators 102, 108, 2002, and 2004 were provided on top and bottom layers of FR4 substrate. The coils 102 and 108 had 14 turns (7 on the top layers and 7 on the bottom layers), an inner diameter of 72 mm, a trace width of 2 mm, and a radius variation of 4 mm between successive turns. Both plates 130a and 130b were copper sheets with surface areas of 22 cm×26 cm. The dielectric between the plates 130a and 130b was air. The distance between the coils and the plates was 1.7 cm. The gap between the coils was 8 mm. The capacitors 210 and 214 had a capacitance of 22 nF, while the capacitors 2006 and 2008 had a capacitance of 220 nF.

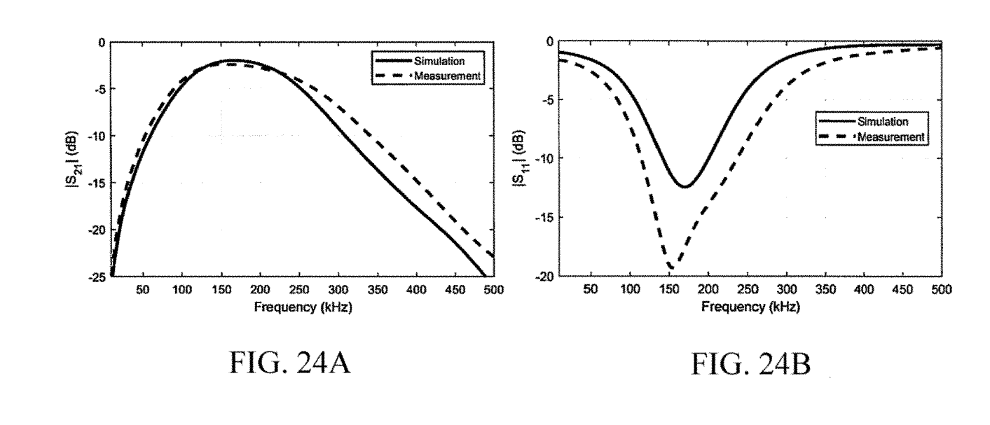

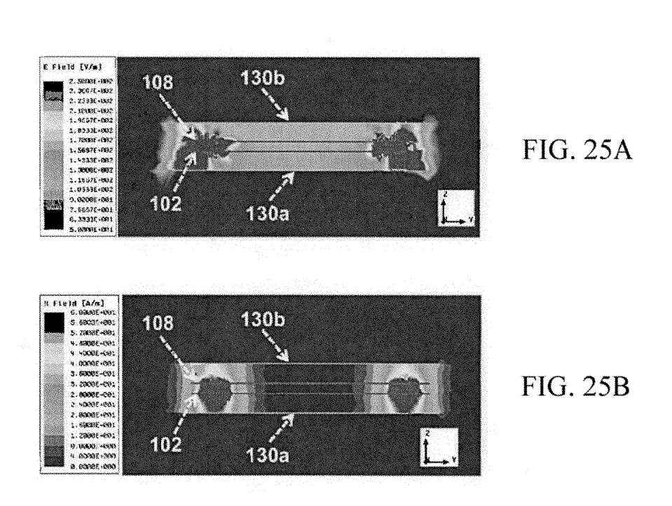

FIGS. 24A and 24B show the simulation and measurement results of S11 and S21, respectively, for the embodiment presented in FIG. 23. For the simulation results, at a frequency of 165 kHz, there is a peak of S21=−1.96 dB and a corresponding S11=−12.4 dB. For the measurement results, at a frequency of 155 kHz, there is a peak where S21=−2.36 dB and a corresponding S11=−19.2 dB. There is a 10 kHz frequency shift in the response due to capacitor uncertainty and fabrication errors, but the frequency of operation is in the standard range of 80-300 kHz and acceptable. The system presented in FIG. 23 has the advantage of electromagnetic shielding as can be seen from electric and magnetic field strength in FIGS. 25A and 25B, respectively.

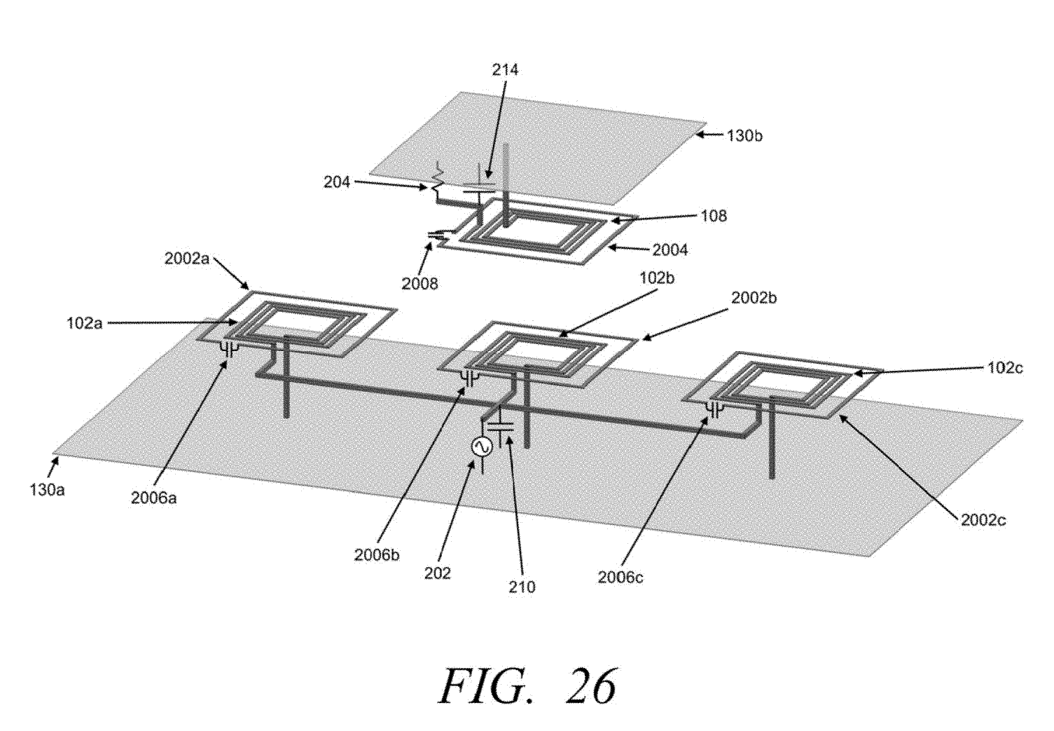

FIG. 26 demonstrates a multi-transmitter single-receiver embodiment of the system in FIG. 23. The system works based on a resonance between one of the transmitter structures and the receiver. For example, if the receiver is on top of transmitter 102b, resonance comes from coupled coils 102b, 2002b, 2004, and 108 and capacitors comprising plates 130a and 130b, between coil 102b and plate 130a, and between coil 108 and plate 130b. In this case, the power only goes through the coil 102b, and the other coils 102a and 102c have no current as they are outside of the resonance condition. The capacitor 210 matches the source 202 to the coils 102a-c. The other ends of coils 102a-c are shorted to the plate 130a. The resonators 2002a-c are tuned to the resonance frequency by changing the capacitors 2006a-c. The capacitor 214 matches the load 204 to the coil 108. The other end of coil 108 is shorted to the plate 130b. The resonator 2004 is tuned to the resonance frequency by changing the capacitor 2008.

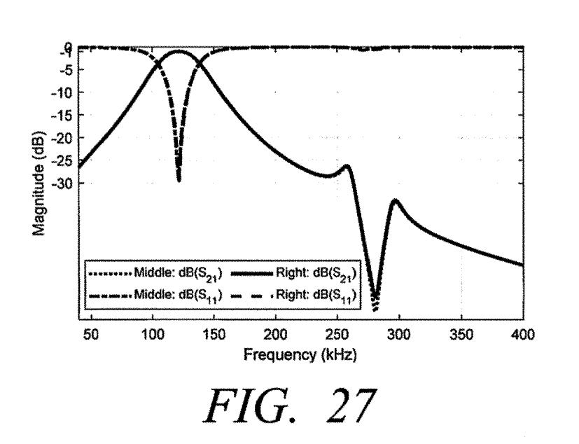

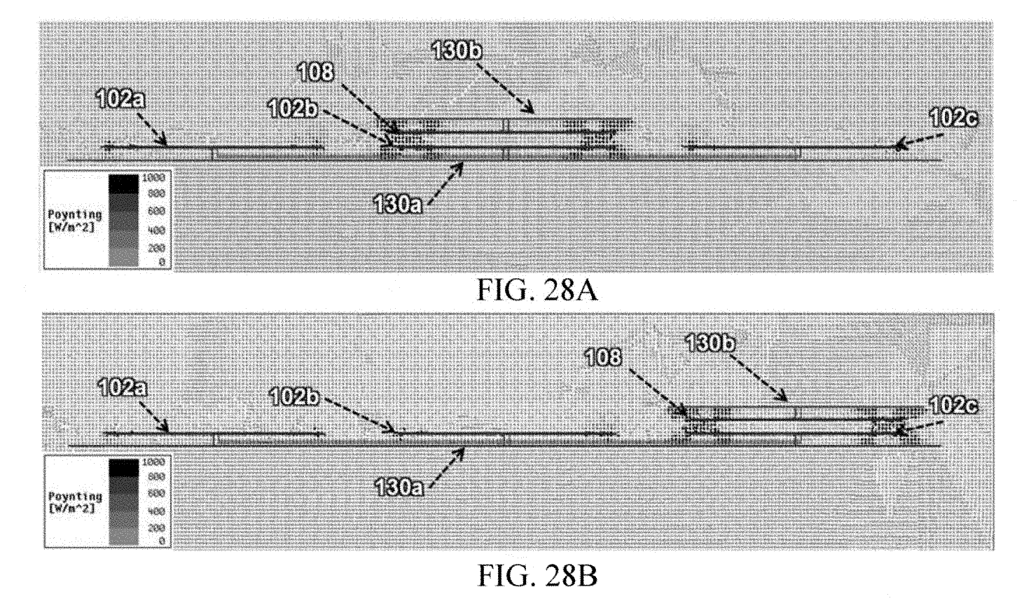

The simulation results of scattering parameters and the Poyntig vector for the two cases of the receiver positioned over each of the middle and the right coils are shown in FIGS. 27, 28A, and 28B, respectively. At a frequency of 120 kHz, there is a peak of S21=−0.97 dB and a corresponding S11=−28 dB for both cases of the receiver positioned over each of the middle and the right coils. It can be seen that the Poyntig vector is significant only for the transmitter coil covered by the receiver, i.e. the middle coil in FIG. 28A and the right coil in FIG. 28B. This embodiment provides a multi-transmitter system for covering more space without using switches that conventionally are used to select the transmitter coil from a bundle of transmitting coils.

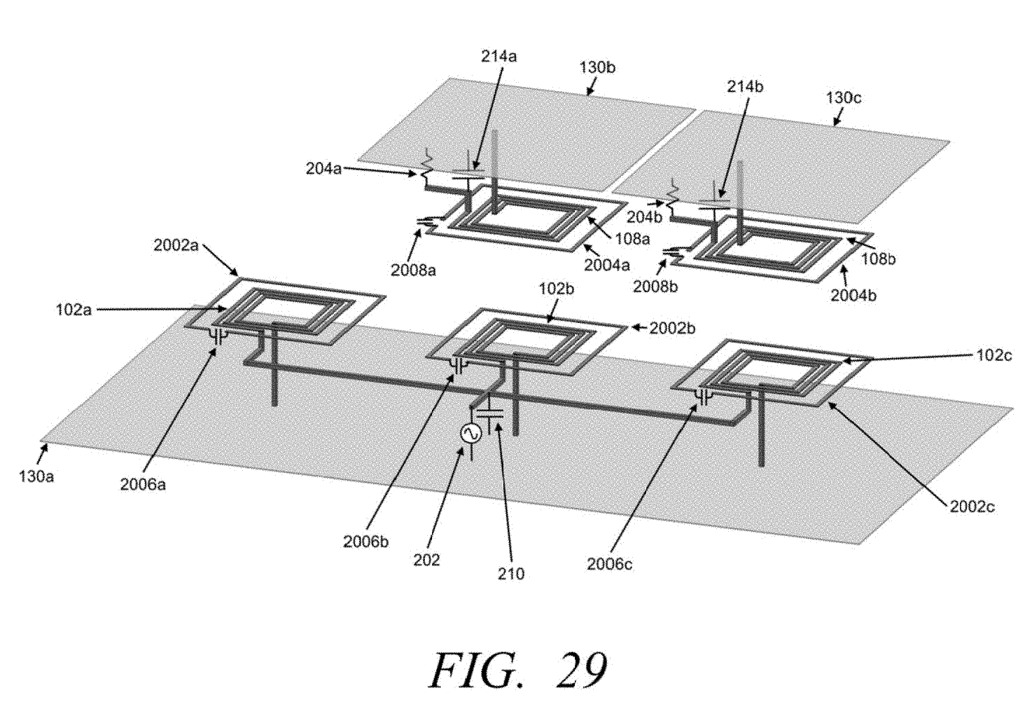

FIG. 29 demonstrates a multi-transmitter multi-receiver embodiment of the system shown in FIG. 26. The dimensions and capacitor values are the same as in the system of FIG. 26. The system works based on the resonances between some of the transmitters coupling with some of the receivers. For example if two receivers are on top of transmitters b and c, one resonance comes from coupled coils 102b, 2002b, 2004a, and 108a and capacitors comprising plates 130a and 130b, between coil 102b and plate 130a, and between coil 108a and plate 130b, and the other resonance comes from coupled coils 102c, 2002c, 2004b, and 108b and capacitors comprising plates 130a and 130c, between coil 102c and plate 130a, and between coil 108b and plate 130c. In this case, the power goes through the coil 102b and the coil 102c and the other coil 102a has no current as it is outside of the resonance condition.

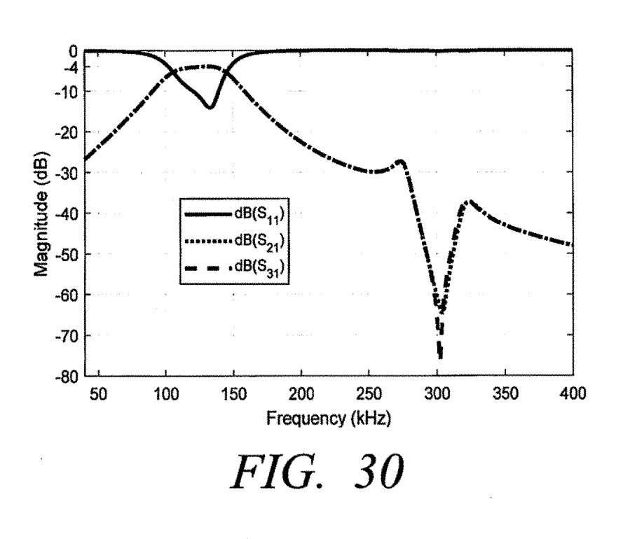

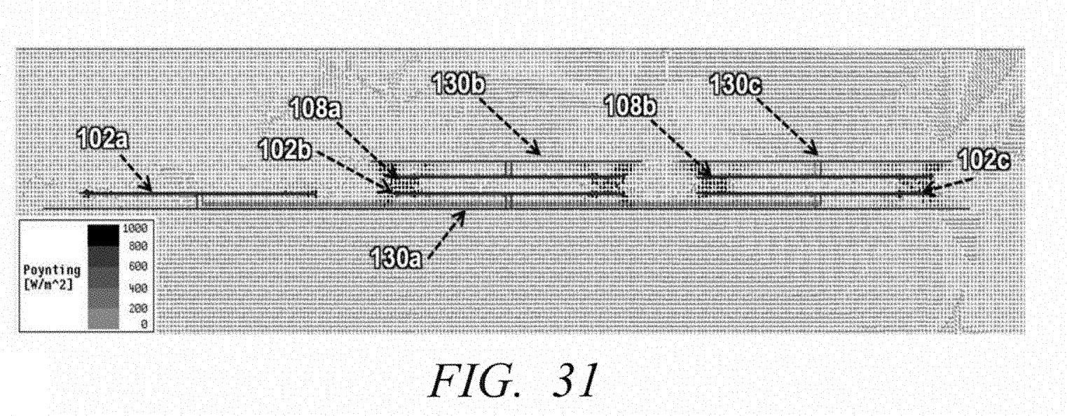

The simulation results of scattering parameters and the Poyntig vector are shown in FIGS. 30 and 31, respectively. At a frequency of 130 kHz, there is a peak of S21=S31=−3.92 dB and a corresponding S11=−14 dB for receivers positioned over the middle and the right coils. It can be seen that the Poyntig vector is significant only for transmitter coils that are covered by the receivers, i.e. the middle and the right coils. This embodiment provides a multi-transmitter multi-receiver system to cover more space and support more receivers, without using switches or a power divider.

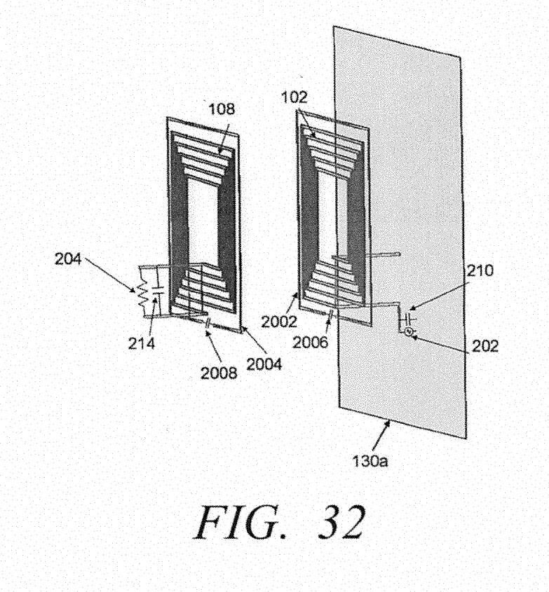

FIG. 32 demonstrates another embodiment of the system of FIG. 23, but with a conventional Qi standard receiver, i.e. without a metallic plate at the receiver. The system works based on a resonance which comes from coupled coils 102, 2002, 2004, and 108 and capacitors, between coil 102 and plate 130a, and between coil 108 and plate 130a. The operating frequency is in the range of 80-300 kHz which is compatible with medium-power Qi chargers. On the transmitter side, the coil 102 is above the plate 130a and makes a short-ended transmission line that generates an electromagnetic field above the plate and around the coil. A capacitor 210 is in parallel with the coil 102 and provides matching between the source 202 and the coil 102. For a fixed distances between coil 102 and plate 130a and between coil 102 and coil 108, a fixed capacitor can be used. The resonator 2002 is coupled to coil 102 and resonates at the operating frequency when the receiver is on top of the transmitter. The resonant frequency of resonator 2002 can be adjusted by changing the value of capacitor 2006. On the receiver side, the coil 108 absorbs electromagnetic fields and generates a current through a load 204. A capacitor 214 is in parallel with the coil 108 and provides matching between the load 204 and coil 108. The resonator 2004 is coupled to coil 108 and resonates at the same frequency as resonator 2002. The resonant frequency of resonator 2004 can be tuned by changing the value of capacitor 2008. The resonators 2002 and 2004 are used to extend the transmitter-receiver distances up to 40 millimeters as expected for Qi chargers.

This system was designed to work at 81 kHz. The coils and resonators 102, 108, 2002, and 2004 were built on top and bottom layers of FR4 substrate. The coils 102 and 108 have 14 turns (7 on the top layer and 7 on the bottom layer), an inner diameter of 72 mm, a trace width of 2 mm, and a radius variation of 4 mm between successive turns. The plate 130a is a copper sheet with a surface area of 22 cm×26 cm. The distance between the transmitter coil and plate 130a is 1 cm and the gap between the coils is 1.7 cm. The capacitors 210 and 214 had capacitances of 120 nF and 70 nF, respectively, while the capacitors 2006 and 2008 both had a capacitance of 600 nF.

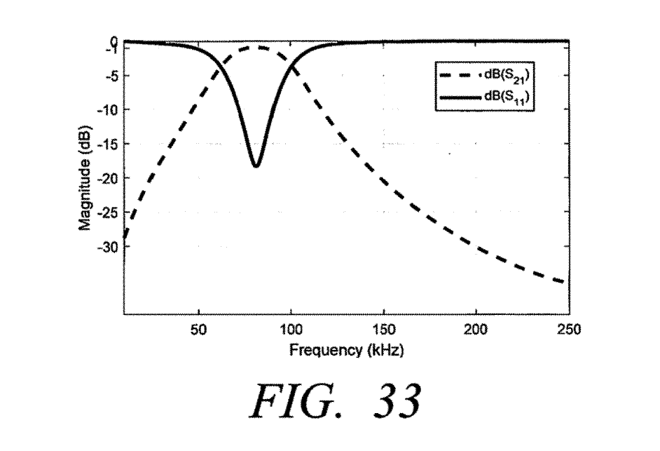

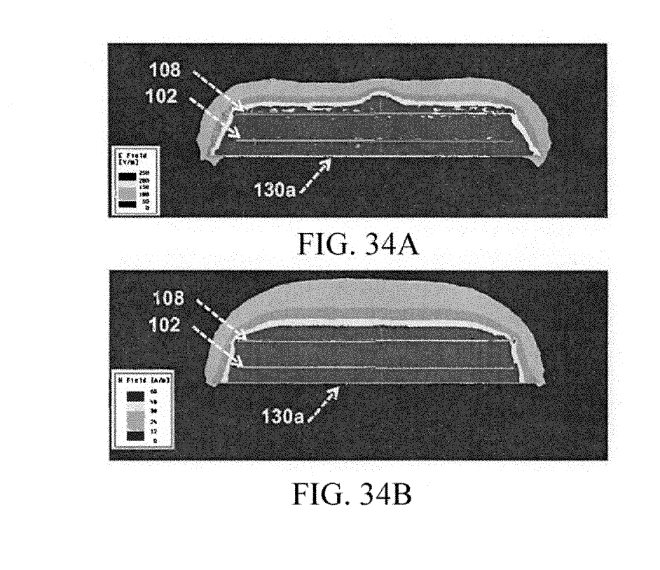

FIG. 33 shows the simulation results of S11 and S21, for the embodiment presented in FIG. 32. At a frequency of 82 kHz, there is a peak of S21=−0.89 dB and a corresponding S11=−18.3 dB. The system presented in FIG. 32 has the advantage of electromagnetic shielding on the back side of the transmitter, as can be seen from the electric and magnetic field strength in FIGS. 34A and 34B, respectively.

While the disclosure has been described in connection with specific embodiments, it is to be understood that the disclosure is not limited to these embodiments, and that alterations, modifications, and variations of these embodiments may be carried out by the skilled person without departing from the scope of the disclosure. It is furthermore contemplated that any part of any aspect or embodiment discussed in this specification can be implemented or combined with any part of any other aspect or embodiment discussed in this specification.

1. A receive-side system for wireless power transmission, the system comprising:
a receive-side single conductor for electrically coupling to a transmitter;
a receive-side single-ended coupler for receiving power from an alternating current power source via the receive-side single conductor;
a receive-side receiving device for transferring power to a load, wherein the receive-side receiving device is configured to be inductively coupled to the receive-side single-ended coupler, and be collectively at resonance with a transmit-side transmitting device, when the power source is operating at an operating frequency; and
one or more discrete components electrically connected to the receive-side single conductor, wherein the one or more discrete components comprise one or more of a capacitor; a resistor; and an inductor.

2. The system of claim 1, wherein the receive-side single-ended coupler comprises first and second ends, and wherein the receive-side single conductor comprises a conducting structure electrically coupled to the receive-side single-ended coupled via the first end.

3. The system of claim 2, wherein the conducting structure comprises a non-wire conducting structure.

4. The system of claim 2, wherein the first and second ends are electrically connected in parallel to the conducting structure.

5. The system of claim 2, wherein the second end is floating.

6. The system of claim 1, wherein the receive-side single-ended coupler comprises a helix with a resonant length approximately an eighth of a wavelength of a signal output by the power source, plus an integer multiple of a half wavelength of the signal.

7. The system of claim 1, further comprising a receive-side coupler tuning network comprising at least one reactive discrete component connected in series with the receive-side single-ended coupler or in parallel across two locations along the receive-side single-ended coupler.

8. The system of claim 7, wherein the at least one reactive discrete component comprises a first and a second capacitor, the first end of the receive-side single-ended coupler being electrically coupled to the conducting structure via the first capacitor, and the second end of the receive-side single-ended coupler being electrically coupled to the conducting structure via the second capacitor.

9. The system of claim 1, further comprising a receiving device tuning network connected to the receive-side receiving device and for connecting to the load, the receiving device tuning network being configured to assist the receive-side receiving device being inductively coupled to the receive-side single-ended coupler, and being substantially at resonance, when the power source is operating at the operating frequency.

10. The system of claim 7, wherein the receive-side coupler tuning network comprises a reactive component bank and wherein the system further comprises control circuitry configured to:
(a) read a feedback parameter of the system; and
(b) in response to the feedback parameter, adjust the reactance of the reactive component bank such that the feedback parameter approaches a target value.

11. The system of claim 9, wherein the receiving device tuning network comprises a reactive component bank and wherein the system further comprises control circuitry configured to:
(a) read a feedback parameter of the system; and
(b) in response to the feedback parameter, adjust the reactance of the reactive component bank such that the feedback parameter approaches a target value.

12. The system of claim 1, wherein the one or more discrete components comprise one or more capacitors, the one or more capacitors comprising capacitive plates separated by dielectrics, and wherein one or more of the capacitive plates comprise:
an assembly for an electronic device, wherein the assembly comprises a conductive protective cover for the electronic device, or a protective cover for the electronic device and a conductive plate for positioning alongside the protective cover;
a conductive plate comprised in a vehicle;
a conductive portion of a conduit;
a table assembly comprising a table and a conductive plate for positioning alongside the table; and
a conductive coating.

13. The system of claim 1, wherein the receive-side receiving device comprises a coil or a toroid.

14. The system of claim 1, further comprising the load connected to the receive-side receiving device, and wherein the load comprises a module for communicating data to or from the load.

15. The system of claim 1, further comprising the load connected to the receive-side receiving device, wherein the load is connected to the receive-side receiving device by one or more of: capacitive coupling; magnetic coupling; and optical coupling.

16. The system of claim 1, further comprising a reflector for one or more of:
reflecting an electric or a magnetic field generated by the receive-side single-ended coupler or the receive-side receiving device, when the power source is operating at the operating frequency; and
shielding a user from the one or more discrete components.

17. The system of claim 1, further comprising one or more additional pairs of: receive-side single-ended couplers for receiving power from the power source via the receive-side single conductor; and receive-side receiving devices for transferring power to one or more additional loads, wherein the one or more additional receive-side receiving devices are configured to be inductively coupled to the one or more additional receive-side single-ended couplers, and be substantially at resonance, when the power source is operating at the operating frequency.

18. A transmit-side system for wireless power transmission, the system comprising:
a transmit-side single conductor for electrically coupling to a receiver;
a transmit-side single-ended coupler for transmitting power from an alternating current power source via the transmit-side single conductor;
a transmit-side transmitting device for transferring power from the power source, wherein the transmit-side transmitting device is configured to be inductively coupled to the transmit-side single-ended coupler, and be collectively at resonance with a receive-side receiving device, when the power source is operating at an operating frequency; and
one or more discrete components electrically connected to the transmit-side single conductor, wherein the one or more discrete components comprise one or more of a capacitor; a resistor; and an inductor.

19. The system of claim 18, wherein the transmit-side single-ended coupler comprises first and second ends, and wherein transmit-side single conductor comprises a conducting structure electrically coupled to the transmit-side single-ended coupled via the first end.

20. The system of claim 19, wherein the conducting structure comprises a non-wire conducting structure.

21. The system of claim 19, wherein the first and second ends are electrically connected in parallel to the conducting structure.

22. The system of claim 18, wherein the one or more discrete components comprise one or more of:
an assembly for an electronic device, wherein the assembly comprises a conductive protective cover for the electronic device, or a protective cover for the electronic device and a conductive plate for positioning alongside the protective cover;
a conductive plate comprised in a vehicle;
a conductive portion of a conduit;
a table assembly comprising a table and a conductive plate for positioning alongside the table; and
a conductive coating.

23. The system of claim 18, wherein the transmit-side single-ended coupler comprises a helix with a resonant length approximately an eighth of a wavelength of a signal output by the power source, plus an integer multiple of a half wavelength of the signal.

24. The system of claim 18, further comprising the power source, wherein the power output and ground terminals of the power source are physically coupled to two locations on the transmit-side single-ended coupler.

25. The system of claim 18, further comprising a transmit-side coupler tuning network comprising at least one reactive discrete component connected in series with the transmit-side single-ended coupler or in parallel across two locations along the transmit-side single-ended coupler.

26. The system of claim 25, wherein the at least one reactive discrete component comprises a first and a second capacitor, the first end of the transmit-side single-ended coupler being electrically coupled to the conducting structure via the first capacitor, and the second end of the transmit-side single-ended coupler being electrically coupled to the conducting structure via the second capacitor.

27. The system of claim 18, further comprising a transmitting device tuning network connected to the transmit-side transmitting device and for connecting to the power source, the transmitting device tuning network being configured to assist the transmit-side transmitting device being inductively coupled to the transmit-side single-ended coupler, and being substantially at resonance, when the power source is operating at the operating frequency.

28. The system of claim 25, wherein the transmit-side coupler tuning network comprises a reactive component bank and wherein the system further comprises control circuitry configured to:
(a) read a feedback parameter of the system; and
(b) in response to the feedback parameter, adjust the reactance of the reactive component bank such that the feedback parameter approaches a target value.

29. The system of claim 27, wherein the transmitting device tuning network comprises a reactive component bank and wherein the system further comprises control circuitry configured to:
(a) read a feedback parameter of the system; and
(b) in response to the feedback parameter, adjust the reactance of the reactive component bank such that the feedback parameter approaches a target value.

30. The system of claim 18, wherein the transmit-side transmitting device comprises a coil or a toroid.

31. The system of claim 18, further comprising a reflector for one or more of:
reflecting an electric or a magnetic field generated by the receive-side single-ended coupler or the receive-side receiving device, when the power source is operating at the operating frequency; and
shielding a user from the one or more discrete components.

32. The system of claim 18, further comprising one or more additional pairs of: transmit-side single-ended couplers for transmitting power from the power source via the transmit-side single conductor; and transmit-side transmitting devices for transferring power from the power source, wherein the one or more additional transmit-side transmitting devices are configured to be inductively coupled to the one or more additional transmit-side single-ended couplers, and be substantially at resonance, when the power source is operating at the operating frequency.

33. A system for wireless power transmission, the system comprising:
a transmitter;
a transmit-side single-ended coupler for transmitting power from an alternating current power source via the transmitter;
a transmit-side transmitting device for transferring power from the power source, wherein the transmit-side transmitting device is configured to be inductively coupled to the transmit-side single-ended coupler when the power source is operating at an operating frequency;
a receiver configured to be electrically coupled to the transmitter;
a receive-side single-ended coupler for receiving power from the power source via the receiver; and
a receive-side receiving device for transferring power to a load, wherein the receive-side receiving device is configured to be inductively coupled to the receive-side single-ended coupler when the power source is operating at the operating frequency,
wherein the system is configured to be collectively at resonance when the power source is operating at the operating frequency.

34. The system of claim 33, further comprising one or more receive-side discrete components electrically connected to the receiver, wherein the one or more receive-side discrete components comprise one or more of a capacitor; a resistor; and an inductor.

35. The system of claim 33, further comprising one or more transmit-side discrete components electrically connected to the transmitter, wherein the one or more transmit-side discrete components comprise one or more of a capacitor; a resistor; and an inductor.

36. The system of claim 33, wherein:
the transmitter at least substantially encloses the receiver; or
the receiver at least substantially encloses the transmitter.
